(19) United States
(12) Patent Application Publication
(10) Pub. No.: US 2008/0319830 A1
(43) Pub. Date: Dec. 25, 2008

(54) CREATING A PRICING PLAN OF RECORD

(76) Inventor: James D. Clayton, Los Altos Hills, CA (US)

Correspondence Address: STRATEGIC PATENTS P.C.., C/O PORTFOLIOIP, P.O. BOX 52050, MINNEAPOLIS, MN, 55402, US

(21) Appl. No.: 12/051,369

(22) Filed: Mar. 19, 2008

Related U.S. Application Data
(60) Provisional application No. 60/895,715, filed on Mar. 19, 2007.

(51) Int. Cl. G06F 17/30

(52) U.S. Cl. 705/10; 705/7

(57) ABSTRACT

In embodiments, the present invention provides a method and system for creating a pricing plan. The method may include receiving a baseline including at least one entity plan, creating a pricing plan, validating an assumption used in creating the pricing plan, and making the pricing plan available to a price planner for implementing the pricing guidelines. The pricing plan may include pricing guidelines that, when applied to units for sale, are projected to yield results conforming to at least one objective of the at least one entity plan. The method may further include receiving approval to transmit the pricing plan. Furthermore, the method may include transmitting an alert when validating the assumption fails.

### CROSS-REFERENCE TO RELATED APPLICATIONS

This application claims the benefit of the following U.S. provisional application, which is hereby incorporated by reference in its entirety:

U.S. Provisional App. No. 60/895,715 filed Mar. 19, 2007.

### BACKGROUND

1. Field

The methods and systems described herein generally relate to enterprise financial management, and specifically relate to price planning and management to meet business objectives.

2. Description of the Related Art

Companies have high-level plans that they use to report on their business and to drive their overall business strategy, and they have low-level plans that they use in the execution of their businesses. The high-level plans are frequently divorced from the low-level plans, managed by different individuals using different data sets, software tools, and processes.

Organizations today require greater control over their operations than in the past. The business landscape has become much more competitive, especially as the economy has become more global. For many companies, managing in this increasing unpredictable environment has become a growing challenge—where creating, managing and meeting expectations has real impact on enterprise value. Today, there is a lack of connection between top-down corporate planning and performance measurement and bottom-up execution. This disconnect causes the key business drivers of price and volume to be influenced and managed differently across the various functional silos in the organization. As a result, information and assumptions behind price and volume do not propagate through the business as results reveal themselves during an operating period. For many businesses, this means employing ad-hoc and manual spreadsheet-driven processes to connect projected performance with current execution and to create scenarios to test the tradeoffs from which to drive the business toward hitting the financial targets.

There remains a need for methods and systems that make a connection between certain high level plans and certain low level plans by establishing a new pricing planning methods and systems.

### SUMMARY

The methods and systems described herein may make a connection between certain high level plans and certain low level plans of an entity by establishing a pricing plan of record that integrates high- and low-level plans of the entity. A range of modules, applications, process flows, tools and features may be associated with developing, maintaining and updating a pricing plan of record. The pricing plan of record for an entity may thus connect heretofore-disconnected plans via the pricing plan of record and related tools and processes.

A price-planning platform may provide benefits to proactively manage a business by facilitating users' understanding of what parts of a business are “off plan” based at least partially on performance to date, such as may result from unanticipated changes in market conditions. The platform may allow planners to consider and manage a range of variables that relate to pricing, such as product mix, unit costs, volume pricing effects, discounting effects, or the like at various levels of the business. With the price-planning platform, users may understand what parts of the business could be “off-plan” in the future if current trends continue, thereby allowing the organization to proactively manage forward on a continuous basis. Setting product or service pricing in context of an overall plan, such as a financial or aggregate demand plan, may result in price alignment at all levels of the business, thereby allowing price-planning platform users to manage prices in the aggregate while handling complex business environment tradeoffs between SKU's, product lines, and/or business units.

The methods and/or systems described herein may involve role-based dashboards and alerts that may provide each user with his/her own view of the price planning process and that may be tailored by the user for aspects such as display, calculations, fields, and the like.

The methods and/or systems described herein may involve tradeoff modeling which may enable users to make midcourse pricing corrections to facilitate achieving a financial plan.

In an embodiment, the price-planning platform may provide closed-loop write-back capabilities to execution systems to facilitate efficient execution of pricing actions.

The methods and/or systems described herein may involve a web user interface, which may be J2EE compliant for a high degree of flexibility and ease-of-use.

In an embodiment, the price-planning platform facilitates managing business rules in complex models, by enabling users to capture all the interdependencies of the rules pertaining to their business problems.

In embodiments, the present invention provides a method for creating a pricing plan. The method may include receiving a baseline including at least one entity plan, creating a pricing plan, validating an assumption used in creating the pricing plan, and making the pricing plan available to a price planner for implementing the pricing guidelines. The pricing plan may include pricing guidelines that, when applied to units for sale, are projected to yield results conforming to at least one objective of the at least one entity plan. The method may further include receiving approval to transmit the pricing plan. Furthermore, the method may include transmitting an alert when validating the assumption fails.

In embodiments, the making the pricing plan available may occur via a user interface, a dashboard, a system interface, an application interface, or the like. Further, making the pricing plan available may include transmitting a guideline. The guideline may be related to the pricing plan of record. Furthermore, making the pricing plan available may include transmitting an alert.

In embodiments, the receiving may occur via a user interface, a dashboard, a system interface, an application interface, or the like. In embodiments, the entity plan may be a promotion plan, marketing plan, a distribution plan, a purchasing plan, an inventory plan, a procurement plan, a corporate plan, an enterprise plan, a financial plan, a sales plan, a resource plan, a supply chain plan, a strategic plan, or the like.

In embodiments, the baseline may further include at least one of an adjustable parameter, an adjustable attribute, and an adjustable rule. Further, the baseline may include data considered in analysis. Furthermore, the baseline may include at least one error factor and at least one estimation.

In embodiments, the pricing plan may include at least one range. Further, the pricing plan may include a range and error bars.

In embodiments, the present invention may provide a system for creating a pricing plan. The system may include a price-planning platform having an input module, a facility for creating a pricing plan, and an output module. The pricing plan may be directed at fulfilling goals of both a financial plan and a demand plan. The input module may be adapted to receive a baseline. The baseline may include the financial plan and the demand plan. Further, the output module may be adapted to make available the pricing plan.

In embodiments, the input and output may include a user interface, a system interface, an application interface, or the like. The user interface may further include a dashboard. Further, the output may be adapted to transmit an alert.

In embodiments, the baseline may further include at least one of an adjustable parameter, an adjustable attribute, and an adjustable rule. Further, the baseline may include data considered in analysis. Furthermore, the baseline may include at least one error factor and at least one estimate.

In embodiments, the pricing plan may include at least one range. Further, the pricing plan may include a range and error bars.

In embodiments, the present invention provides another method for creating a pricing plan. The method may include receiving a baseline including at least two entity plans, creating a pricing plan, validating an assumption used in creating the pricing plan, creating a guideline related to the pricing plan, and making available the pricing plan and the guideline. The pricing plan may include pricing figures that, when applied to units for sale, are projected to yield results substantially conforming to objectives of the at least two entity plans. The method may further include receiving approval to transmit the pricing plan. Furthermore, the method may include transmitting an alert when validating the assumption fails.

In embodiments, the making available may occur via a user interface, a dashboard, a system interface, an application interface, or the like. Further, making available may include transmitting a guideline. The guideline may be related to the pricing plan of record. Furthermore, making available may include transmitting an alert.

In embodiments, the receiving may occur via a user interface, a dashboard, a system interface, an application interface, or the like. In embodiments, the entity plan may be a promotion plan, marketing plan, a distribution plan, a purchasing plan, an inventory plan, a procurement plan, a corporate plan, an enterprise plan, a financial plan, a demand plan, a sales plan, a resource plan, a supply chain plan, a strategic plan, or the like.

In embodiments, the baseline may further include at least one of an adjustable parameter, an adjustable attribute, and an adjustable rule. Further, the baseline may include data considered in analysis. Furthermore, the baseline may include at least one error factor and at least one estimate.

In embodiments, the pricing plan may include at least one range. Further, the pricing plan may include a range and error bars.

In embodiments, the guideline may include a unit cost, a promotion, a discount, a time, a range of prices, a range of dates, a range of discount, or the like. The guideline may relate to a SKU.

In embodiments, the present invention provides a price-planning platform. The price-planning platform may include an input module adapted to receive a baseline including at least two entity plans, a facility adapted to create a pricing plan, a facility adapted to validate an assumption used in creating the pricing plan, a guideline manager adapted to create a guideline related to the pricing plan, and an output module adapted to make available the pricing plan and the guideline. The pricing plan may include pricing figures that, when applied to units for sale, are projected to yield results substantially conforming to objectives of the at least two entity plans.

In embodiments, the making available may occur via a user interface, a dashboard, a system interface, an application interface, or the like. Further, making available may include transmitting a guideline. The guideline may be related to the pricing plan of record. Furthermore, making available may include transmitting an alert.

In embodiments, the receiving may occur via a user interface, a dashboard, a system interface, an application interface, or the like. In embodiments, the entity plan may be a promotion plan, marketing plan, a distribution plan, a purchasing plan, an inventory plan, a procurement plan, a corporate plan, an enterprise plan, a financial plan, a demand plan, a sales plan, a resource plan, a supply chain plan, a strategic plan, or the like.

In embodiments, the baseline may further include at least one of an adjustable parameter, an adjustable attribute, and an adjustable rule. Further, the baseline may include data considered in analysis. Furthermore, the baseline may include at least one error factor and at least one estimate.

In embodiments, the pricing plan may include at least one range. Further, the pricing plan may include a range and error bars.

In embodiments, the guideline may include a unit cost, a promotion, a discount, a time, a range of prices, a range of dates, a range of discount, or the like. The guideline may relate to a SKU.

In embodiments, the input and output may include a user interface, a system interface, an application interface, or the like. The user interface may further include a dashboard. Further, the output may be adapted to transmit an alert.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a price-planning platform.

FIG. 1A depicts general business planning.

FIG. 2 depicts a price-planning platform system and/or method.

FIG. 3 depicts a target global and a component pricing plan of record.

FIG. 4 depicts a global pricing plan decomposed into components.

FIG. 5 depicts a business practice of continuously re-planning pricing activity throughout a period as results are obtained.

FIG. 6 depicts an exemplary business plan and operation cycle.

FIG. 7 depicts an exemplary flow associated with creating a pricing plan of record.

FIG. 8 depicts an exemplary baseline input screen of the price-planning platform.

FIG. 9 depicts an exemplary user display of price plan development and comparison.

FIG. 10 depicts an exemplary pricing plan of record validation screen.

FIG. 11 depicts an alternative view of a subset of the validation screen of FIG. 10.

FIG. 12 depicts a pricing plan adjustment flow associated with pricing plan activity during an operating period.

FIG. 13 depicts a graph of several aspects associated with understanding the gap in current and projected performance.

FIG. 14 depicts a table of several aspects associated with understanding the gap in current and projected performance.

FIG. 15 depicts the graph of FIG. 13 with updated estimates from the table of FIG. 14.

FIG. 16 depicts an exemplary validation screen of revised pricing plan per the table of FIG. 14.

FIG. 17 depicts a guide line manager flow.

FIG. 18 depicts a product line identifier screen.

FIG. 19 depicts a product identifier screen.

FIG. 20 depicts a user screen for adjusting discount rate targets.

FIG. 21 depicts a method of creating a pricing plan.

FIG. 22 depicts a method of adjusting a pricing plan.

FIG. 23 depicts a method of a guideline manager.

### DETAILED DESCRIPTION

A pricing plan may be a plan of record of an enterprise, linking other plans, including high level plans (e.g. the finance plan, strategic plans, etc.) with low-level plans (e.g. demand plans, unit sales plans, etc.). Thus, the pricing plan takes inputs from other enterprise plans and “solves” for a pricing plan (or the set of possible pricing plans) that satisfies the linked conditions of the other plans (or sends an alert if there is no way to harmonize the other plans). An objective function of the pricing plan of record (and an application to produce it) is taken from the financial plan of record, such as constrained by the strategy of the enterprise.

In a simplified example of a price-planning platform, a company may have only one product type for sale. The pricing plan may take an input from a financial plan of the company that says the total sales this quarter will be $10,000,000, and input from the company demand plan that says that 1,000,000 units will be delivered this quarter. In this simple example of the pricing plan, the pricing plan solves for the average price ($10 per unit in this example) at which the company needs to sell its product in order for the demand plan to align with the financial plan.

However most companies have many product types (which may be represented as SKUs), so the pricing plan of record may decompose a high-level financial plan top line revenue number to the product type/SKU level. In this way the pricing plan may solve for an average price guideline for each SKU, so that the anticipated volume sold of each SKU times the average price of the SKU, summed over all the SKUs equals the top line revenue number of the financial plan. As the top level plan is decomposed or disaggregated, it becomes possible for individuals responsible for particular SKUs or collections of SKUs, such as product line managers, to consider a wide range of factors that can influence sales, such as anticipated elasticity of demand, time-based effects (such as end-of-quarter discounting), typical impacts of negotiating and discounting, volume discounts, cross-elasticity of demand (such as impacts on one SKU when prices are changed for another SKU), and the like. By contrast, high-level financial planners, such as the CFO of a large organization, may have only a very rough sense of the impact of pricing, often making crude assumptions about how sales in one quarter might relate to a previous quarter or a similar quarter for a previous year. Meanwhile, the low-level planners may have little sensitivity to the impact of sales changes for their SKUs on the overall plan. The end result for many organizations is that as sales data comes in for a period, such as a quarter, there is an ad hoc effort to revise plans, but often this requires steep last-minute discounting or other compromises, because the impact of individual SKU-level pricing decisions on the overall plan is not considered until late in the period and on an ad hoc basis. With a pricing plan of record, financial planners may adjust parameters of the overall plan and pricing managers may adjust pricing and sales plans, with the impact of both types of adjustments being presented in the price planning platform.

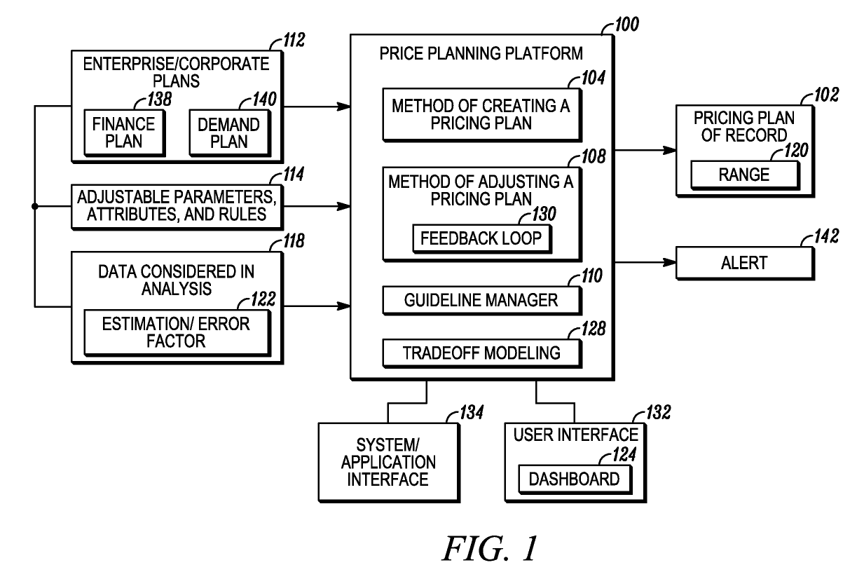

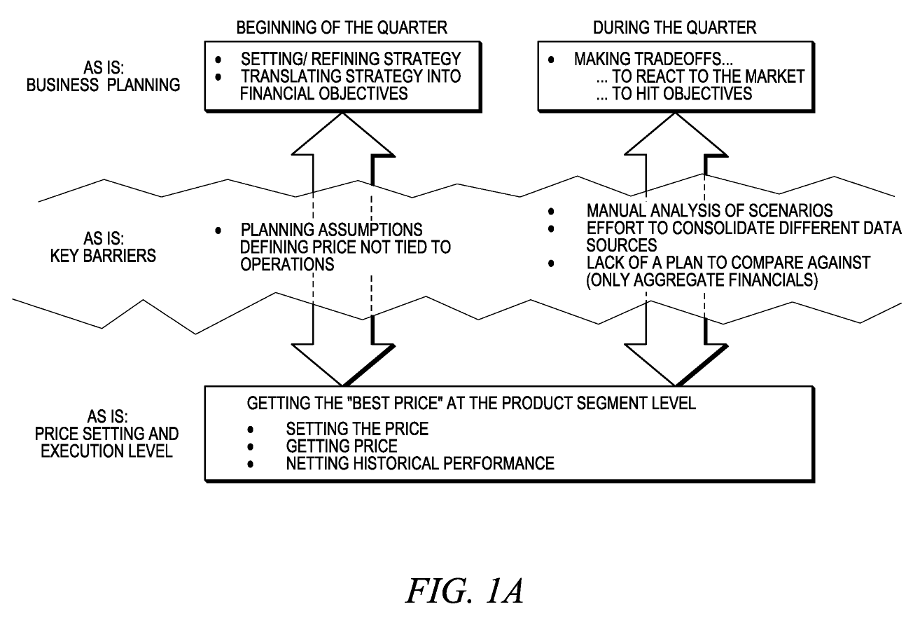

Referring now to FIG. 1, a price-planning platform 100 may include a method of creating a pricing plan 104, a method of adjusting a pricing plan 108, a guideline manager 110, and tradeoff modeling 128. The method of adjusting a pricing plan 108 may include a feedback loop 130. The price-planning platform 100 may receive one or more entity plans 112; one or more adjustable parameters, attributes, and rules 113; and/or data considered in analysis 118. The entity plans 112 may include a finance plan 138, a demand plan 140, and so on. The data considered in analysis 118 may include an estimation/error factor 122. The price-planning platform 100 may include or be operatively coupled to a system/application interface 134 and/or a user interface 132. The user interface 132 may include a dashboard 124. A variety of user interfaces 132 are described herein and elsewhere. It will be understood that an even wider variety of user interfaces 132 is possible. The price-planning platform 100 may produce a pricing plan of record 102. The pricing plan of record 102 may include at least one range 120 or pricing guideline. The price-planning platform 100 may produce an alert 142. Any of the methods described herein may be embodied in one or more systems.

The price-planning platform 100 may integrate with or operatively couple to remote systems and applications via the system/application interface 134. This integration or coupling may allow for communications between the price-planning platform 100 and the remote systems and applications.

The remote systems and applications may without limitation include business processes, business management systems, business applications, and the like. The remote systems and applications may without limitation be directed at finance, accounting, sales, operations, marketing, production, logistics, and so forth.

In embodiments, the system/application interface 134 may include one or more of an application programming interface; a physical interface such as and without limitation an Ethernet port or other physical network component; a logical interface such as and without limitation a TCP/IP network port or other logical network component; and so on. It will be understood that a variety of system/application interfaces 134 are possible.

In embodiments and without limitation, the remote systems may include, for example and without limitation, commercially available systems such as Metreo Guideline Manager™, Metreo Vision™, Metreo Response™, and Metreo Deal Analyzer™.

The price-planning platform 100 may include an interface, which may be a user interface 132, for accepting input and providing output. In embodiments, the user interface 132 may be provided via a terminal; a web browser; a telephone; a mobile device; a personal digital assistant; a laptop computer; an instant messenger; an SMS or MMS messaging facility; or the like. A user may employ the user interface 132 to create all or part of a baseline, for developing a pricing plan, for comparing pricing plans, for modeling effects of pricing guidelines, for adjusting parameters of an overall plan, and so on. It will be understood that a variety of applications of the user interface 132 are possible.

The dashboard 124 may be an element of the user interface 132 and may provide a variety of users with role-based access to the price-planning platform 100. This access may allow a user to receive information from and provide information to the price-planning platform 100. For example and without limitation, this information may include entity plans 112; adjustable parameters, attributes, and rules 114, data considered in analysis 118; and so on. The information may be presented in textual or graphical form, may include aggregated and disaggregated views, may be presented in a more or less flat or hierarchical manner, and so on. In embodiments, roles that may be assigned to users include administrator, executive in charge of P&L, line manager, sales person, and so on. Each role may be associated with its level of access and/or privilege with respect to features, functions, or other aspects of the price-planning platform 100. It will be understood that a variety of embodiments of the dashboard 124 are possible.

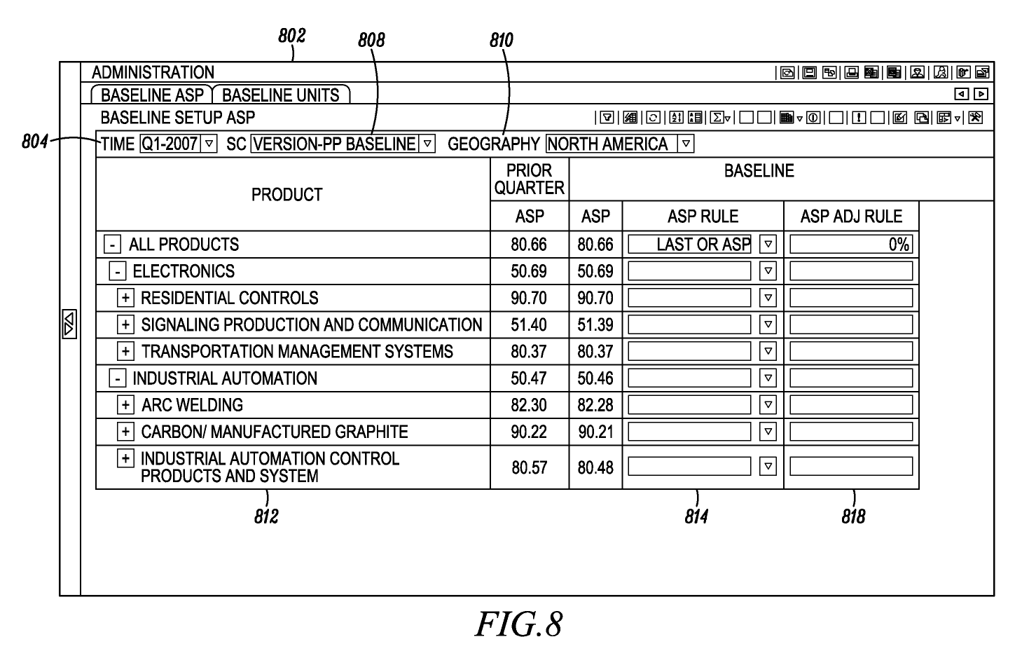

Embodiments of the user interface 132 may be described in detail hereinafter with reference to FIGS. 8, 9, 10, 13, 14, 15, 16, 18, 19, and 20. It will be understood that a variety of user interfaces 132 are possible.

The price planning platform 100 may, from time to time, in whole or in part, receive as its input one or more plans 112, including, without limitation, entity plans; one or more adjustable parameters, attributes, and/or rules 114; and data 118. Its input may be received via the user interface 132 and/or the system/application interface 134.

The price-planning platform 100 may, from time to time, process its input to produce a pricing plan of record 102. The price-planning platform 100 may, from time to time, in whole or in part, publish the pricing plan of record 102. This publication may occur via the user interface 132 and/or via the system/application interface 134 or by other means.

The pricing plan 102 may accommodate estimation/error factors 122 in the input data 118 such as estimation/error factor 122 of a demand plan 140 so that the pricing plan of record 102 may indicate a plurality of price plans based on the estimation/error factors 122, or the pricing plan of record may provide pricing guidelines, such as a range of average selling prices that will achieve the overall plan, subject to conditions. Likewise, estimate/error factors 122 may be applied to a financial plan 138 and may be included in solving for a pricing plan of record 102.

A pricing plan 102 may include modeling of anticipated price impact on demand, such as based on modeled elasticity of demand, historical demand, cross-elasticity of demand among SKUs, market conditions, and the like. Although generally demand may not be affected by a solved price to harmonize the financial 138 and demand 140 plans, if the solved price is too high, then demand may suffer. If the solved price is too low, demand may outpace capacity. Using historical pricing plan and demand data 118 may provide a baseline for a current pricing plan. If the solved price is within a certain range of the historical price, it may be assumed that demand will not be impacted. However, outside the certain range, then it may be assumed that demand will be impacted so that price and demand interact. To flexibly support price/demand impact, the pricing plan 102 may include configurable parameters 114 that determine a ‘non-impact’ range and may trigger an iterative loop 130 with the demand plan outside the range. In an example, if the solved SKU price is within the configured range, such as a historical range, then the demand plan 140 may be treated as a fixed input. Otherwise, the pricing plan 102 facilitates interaction of volume and price to arrive at the overall financial number. The pricing plan 102 may perform iterations based on price elasticity models to arrive at the number.

A pricing plan of record 102 may be optimized to address harmony at a strategic/global level rather than at a transaction level. In this way, the objective function of the pricing plan 102 may be based on the finance plan 138 and constrained by the strategy, rather than just being designed to maximize revenue at a per-transaction level. Although a salesman may want to maximize revenue per transaction, the strategy of the entity as a whole may be harmonizing volume and price to achieve the financial plan 138. The price-planning platform 100 may allow setting of parameters to achieve the strategic financial plan number, through the low level plans, such as the demand plan. This allows price planning to be done in view of a pricing or revenue plan 112 of the entity.

The price-planning platform 100 may allow for establishing a baseline based on aspects of past plans 112. In an example, a baseline might be built using this quarter's upcoming demand plan 140 and last quarter's pricing plan 102. If those two harmonize with the financial plan 138, then the pricing plan of record may be baselined. If not, then it may be necessary to adjust the upcoming quarter's demand 140 or last quarter's pricing plan 102 to meet the financial plan 138. Adjustments may be within acceptable ranges or may trigger alerts, such as to suggest that the high level plan is not realistic. Actual sales numbers can be compared to the baseline during the quarter to check whether the company will in fact hit its plan 112. The baseline may be used to estimate a variance from plan 112, whether as to pricing, volume, or both. The price-planning platform 100 may provide the ability to develop a baseline of what might happen during the planning period if nothing changes. Once the baseline has been developed, the price-planning platform 100 may allow the user to create different tradeoff scenarios in which to drive the business in order to meet the organizational objectives. The price-planning platform 100 may facilitate adjusting the plan throughout the period to address deviations from the plan such as a result of product, market, environmental, or other unpredictability.

In markets that are volume constrained, such as B2B markets, price may become the most significant factor that can be adjusted to change revenue; however, other factors, such as supply capacity, timing and the like may also be modeled in the price planning platform.

The entity plans 112 may relate to an operational period of time such as and without limitation a day, a month, a quarter, a year, or the like. The entity plans 112 may without limitation be directed at market share, margin, revenue, and so on. The entity plans 112 may relate to an entire enterprise, a division of an enterprise, a project, a product line, a product, and so on. The entity plans 112 may without limitation include an enterprise plan, a corporate plan, a finance plan, a revenue plan, a financial plan, a demand plan, a strategic plan, a volume plan, a supply plan, a profit margin plan, a financial revenue plan, a promotion plan, a marketing plan, a distribution plan, a purchasing plan, an inventory plan, a procurement plan, a plan of an enterprise, any and all combinations of the foregoing, and so on. A variety of entity plans 112 may be described herein and elsewhere. It will be understood that an even wider variety of entity plans 112 are possible.

The finance plan 138 (also referred to herein and elsewhere as a “financial plan”) may include one or more financial objectives of an enterprise. These objectives may without limitation relate to revenue, margin, market share, profit, expenses, and so on. The financial objectives may be aggregate, average, strategic, or high-level objectives. For example and without limitation, in an embodiment the financial objectives may be concerned with the average margin across all sales of an enterprise as opposed to the margin of a particular sale of the enterprise. It will be understood that a variety of finance plans 138 are possible.

The demand plan 140 may include one or more unit-volume objectives of an enterprise. These objectives may without limitation relate to production and/or sales of product units, service units, and the like. The unit-volume objectives may be disaggregated, per-unit, tactical, or low-level objectives. For example and without limitation, in an embodiment the unit-volume objectives may be concerned with the gross margin of a particular unit sale as opposed to the average margin across all sales of an enterprise.

In addition to a high-level financial plan 138 and a low-level demand plan 140, other plans 112 may provide input to the price-planning platform to generate the pricing plan of record 102. A financial plan for a whole enterprise may provide input of total revenues this quarter for enterprise to the price-planning platform. The price-planning platform 100 may be configured to ensure that pricing plans 102 do not exceed the total revenue value. A financial plan 138 may be broken down by revenue lines, such as sales of a particular product, sales of a type of product, products versus services, sales by business units, sales by geography, sales by SKU, and the like. A strategic plan 112 may include a market share target (e.g. volume target out of total market estimate) as opposed to a revenue target. The strategic plan 112 may be a condition on the financial plan 138 (e.g., “hit $10 MM this quarter while achieving at least 30 percent market share in Europe and keeping sales at least level in the USA”). Alternatively, or in addition, the strategic plan 112 may therefore be a constraint on the solution space otherwise dictated by the high-level financial plan 138. A demand or volume plan 140 may set the volume that the enterprise expects to sell. Such a volume may be based on assuming no major changes in pricing, or the price changes are within a “non-impact” range, such as a range of historical prices.

The price-planning platform 100 may interact with one or more of these corporate plans 112 so that inputs to the price-planning platform 100 may come from a feedback loop 130 with the other plans 112, 102.

In one particular embodiment, the price-planning platform 100 may solve an enterprise-planning problem. A decision object may be formulated which corresponds to the overall pricing plan 102. This decision object may be composed of a series of other decision objects, which may correspond to individual pricing decisions and other related decisions. A lowest common level of abstraction may be determined. In an embodiment, the lowest common level of abstraction may be determined to be the SKU. Various units, plans, functions, processes and other elements of the enterprise may feed into the pricing plan and/or the price-planning platform.

As may be described in greater detail hereinafter with reference to FIG. 22, the feedback loop 130 may allow the price-planning platform 100 to respond in a real-time, continuous manner. Various decision makers or groups of decision makers may be associated with each plan 112, 102 and/or decision object. These individuals or groups of individuals may create the decision objects and may interact with the decision objects. The price-planning platform 100, or any and all elements included therein or associated therewith, may perform analysis, calculations, and the like to unify the various plans 112 and decide or contribute to the decisions for the various decision objects.

The price-planning platform 100 may facilitate setting parameters associated with pricing for goods and services of an entity. Unlike an entity price list (e.g. a published price list), the price-planning platform 100 may generate a pricing plan of record 102 that results from solving a set of business rules/parameters 114, or the like that govern the prices of an entity's goods and services. The pricing plan of record 102 may include parameters and/or rules 114 associated with selling activity under the plan of record 102. Without limitation, the parameters and/ or rules 114 may include: what prices or price ranges should be set on the price list; how much discount can be offered; price change timing constraints; discount timing constraints; adjustments to a sales force compensation, incentives, commissions; rules for deviating from the plan; discount approval authorities and condition; volume pricing rules, and the like. Additionally, pricing rules 114 may be based on other parameters such as expiration dates, perishable commodities, scarce commodities, market prices of constituent commodities, and the like. For example, pricing guidelines may be more flexible for perishable commodities or goods for which there is a fashion or fad element of demand, as the high-level financial impact of poor sales for such items is more severe than for items that can be sold later at prices similar to those in a current period.

The price-planning platform 100 may examine historical pricing data 118 to set parameters 114 as to price planning for a future period. Such parameters 114 may be settable or adjustable because some markets will accept larger price increases than others, the parameters 114 may, as described herein, also affect when an alert is generated during the pricing planner solving process.

The adjustable parameters, attributes, and rules 114 may without limitation include price, volume, discount, timing of changes (to price, volume, discount, and the like), margin, pricing rules, volume pricing rules, discount rules, adjustments to sales force compensation/incentives/commissions, rules for deviating from a plan, an alert condition, and so on. It will be understood that a variety of adjustable parameters, attributes, and rules 114 are possible.

In embodiments, the price-planning platform 100 may monitor various conditions of an enterprise related to a pricing plan 102. An alert condition may be defined with respect to such conditions of an enterprise. When the enterprise experiences a condition that is an alert condition, the price-planning platform 100 may transmit an alert 142. For example and without limitation, the alert condition may indicate that an alert 142 should be sent if and when the enterprise is 20% behind its quarterly sales-volume objective (such as for a pro-rated portion of the quarterly time period) as defined by a demand plan 140. When data 118 indicates that the enterprise is, in fact, 20% behind the sales goal, the price-planning platform 100 may transmit an alert 142. It will be understood that a variety of alert conditions are possible.

The data 118 may include any and all financial or strategic conditions typically associated with an enterprise may be used as inputs to the price-planning platform 100. The price-planning platform 100 may solve for the pricing plan of record 102 by taking into account the data 118. The data 118 may without limitation include forecasts, historical pricing, real time data, continuous data, demand data, supply data, pricing data, data relating to an impact of price on demand, data relating to an impact of supply on price, data relating to one or more relevant baselines, expiration dates, prices of constituent commodities relative to a good and/or service, and so on.

The price-planning platform 100 may use data 118 in the form of forecast numbers for demand volume, based on information from the demand plan 140. The forecast may be driven by data 118 in the form of sales forecasts, but may also be driven by data 118 indicating unit volumes coming out of a supply chain.

It will be understood that a variety of data 118 is possible.

Tradeoff modeling 128 may be directed at modeling a market's response to pricing of units for sale. In order to model this response, it may be necessary to consider conditions on the market. One condition may be that the probability of making a sale decreases as unit price increases, and vice versa. Another condition may be that demand decreases as price increases, and vice versa. Still another condition may be that a sale of a unit at one price is considered an indication that the sale of the unit would also have occurred if the unit had been offered at a second, lower price.

In tradeoff modeling 128, one may assume that time-dependent factors such as and without limitation trend and seasonality have been removed from transaction data. With this assumption in mind, tradeoff modeling 128 may employ a time series approach: First, a step of time series aggregation may aggregate sales volume and/or sales count. These transactions may have occurred over time. Then, a step of computing quantity-weighted sum of price based on a time window and an offset may occur. For example and without limitation the time window may be 90 days and the offset may be 30 days ago (so, the time window may end 30 days ago). Finally, the tradeoff modeling 128 may run a regression for either a logistic model (producing probabilities that sales will occur) or a log-linear/log-log model (producing expended sales quantities).

In tradeoff modeling 128, one may assume that a particular sales volume or a sale at one price indicates that the sales volume or the sale would have been achieved at a second, lower price. With this assumption in mind, tradeoff modeling may employ a price series approach: First, a step of price attribute aggregation may sort transactions by unit price in order from lowest to highest, aggregating sales volume and/or sales count at each price. These transactions may have occurred over time. Then, a step of calculating the total sales count and total sales volume may occur. These counts may be calculated for transactions falling within a particular time window or may be calculated on or across bins of transactions, each bin containing transactions occurring within its own time window. Next, a quantity-weighted sum of price may be computed based upon the counts. Finally, the tradeoff modeling 128 may run a regression over the quantity-weighted sum of price for either a logistic model (producing the probabilities that sales will occur across a spectrum of prices) or a log-linear/log-log model (producing expected sales quantities across a spectrum of prices). The regression may be run over all transactions, over transactions within a time window, over transactions within various bins, and so forth.

Tradeoff modeling 128 may be directed at problems involving market share, margin, and/or revenue. For example and without limitation, an enterprise may be interested in achieving a particular market share by year's end. To achieve this, the enterprise may employ the price-planning platform to produce a pricing plan of record 102 that, when acted upon, should substantially produce the desired market share. In this example, the tradeoff modeling 128 may be concerned not with total sales numbers per se, but with the enterprises' sales relative to total sales in the market. To this end, transactions representative of the total sales in the market, including transactions representative of the enterprise's sales, may be included in the tradeoff modeling 128.

It will be understood that the price series approach may produce results that comply with the conditions of the market, regardless of which time window may be used.

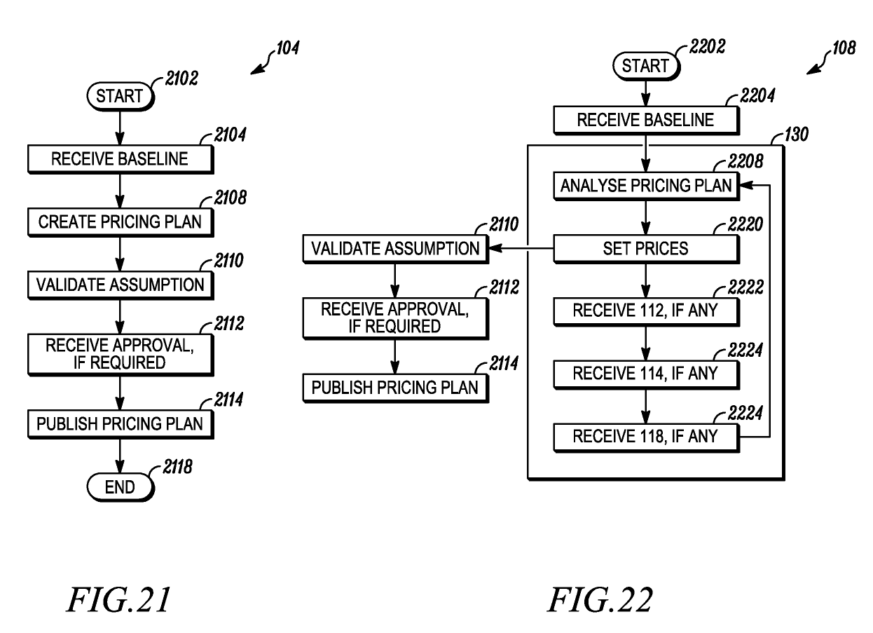

The method of creating a pricing plan 104 may be described in detail hereinafter with reference to FIG. 21 and elsewhere.

The method of adjusting a pricing plan 108 (and the feedback loop 130 therein) may be described in detail hereinafter with reference to FIG. 22 and elsewhere.

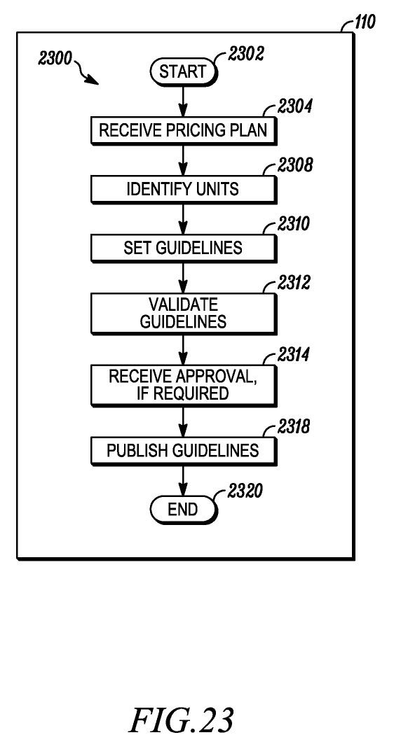

The guideline manager 110 may be described in detail hereinafter with reference to FIG. 23 and elsewhere.

In addition to a high-level financial plan 138 and demand plan 140, other plans 112 may provide input to the price-planning platform 100 to generate the pricing plan of record 120. A financial plan 138 for a whole enterprise may provide input of total revenues this quarter for enterprise to the price-planning platform 100. The price-planning platform 100 may be configured to ensure that pricing plans 102 do not exceed the total revenue value. A financial plan 138 may be broken down by revenue lines, such as sales of a particular product, sales of a type of product, products versus services, sales by business units, sales by geography, sales by SKU, and the like. A strategic plan 112 may include a market share target (e.g. volume target out of total market estimate) as opposed to a revenue target. The strategic plan 112 may be a condition on the financial plan 138 (e.g., hit $10 MM this quarter while achieving at least 30 percent market share in Europe and keeping sales at least level in the USA). Alternatively, or in addition, the strategic plan 112 may therefore be a constraint on the solution space otherwise dictated by the high-level financial plan 138. A demand or volume plan 112 may set the volume that the enterprise expects to sell. Such a volume may be based on assuming no major changes in pricing, or the price changes are within a “non-impact” range, such as a range of historical prices.

The price-planning platform 100 may interact with one or more of these corporate plans 112 so that inputs to the planner may come from a feedback loop 130 with the other plans.

The price-planning platform 100 and resulting pricing plan of record 102 may harmonize low level pricing guidelines, sales programs, and the like with high level financial and demand plans of the entity.

The price-planning platform 100 may take into account factors that result in a pricing plan of record 102 indicating a sale price for an item is different than the price on the price list. The pricing plan of record 102 may show average sale prices for price list items instead of the published list price. In an example, a pricing plan of record 102 may indicate an average price of $10 for an SKU. However, knowing that a typical sale process starts with a list price, includes volume discounts, allows sales people to offer quarter end discounts, includes some rebates and incentive programs, and the like, the pricing plan of record 102 can feed a process that sets parameters that affect the typical sale process.

The price-planning platform 100 may simply take inputs from other plans 112 and output a pricing plan 102. On the other hand, a feedback loop 130 that feeds output parameters of the pricing plan 120 to other plans 112 is fully enabled. For example and without limitation, a margin planner may be established that may harmonize between the pricing plan of record 102 and a sales and marketing plan 112. The margin planner may optimize margin, such as in response to margin goals set for the enterprise at the financial or strategic plan level.

The price-planning platform 100 may, from time to time, produce an alert 142 in response to a condition. The condition may be pre-determined and/or pre-specified by a user or based on historical or other data. The alert 142 may be role based. For example and without limitation, the alert 142 may be directed at and/or delivered to users who have a particular role within an enterprise. The condition may be detected by the price-planning platform 100. The condition may be communicated form a user to the price-planning platform 100. The condition may be raised response to processing of the entity plans 112; the adjustable parameters, attributes, and rules 114; and/or the data 118. It will be understood that a variety of embodiments of the alert 142 are possible.

FIG. 1A depicts how high level business planning (such as financial and demand planning) is disjoined from price setting and execution level operations by key barriers such as high level planning assumptions that define price are not tied to low level operations. FIG. 1 may involve manual analysis scenarios or ad-hoc semi automated scenarios that require substantial and error prone effort to consolidate different data sources that may be updating throughout the cycle. These efforts also lack a plan that relates high level plans of a business with the actual products, services, business units, markets, and supply factors that drive the operation level day by day.

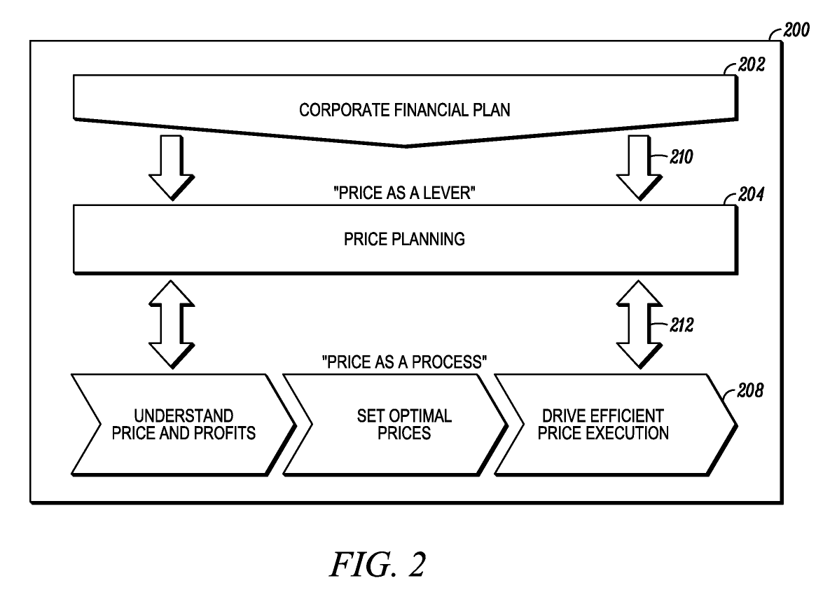

Referring to FIG. 2, a depiction of a price-planning platform 200 system and method, price planning 204 that links the high level planning 202 with low level execution 208 may harmonize the two so that financial and business plans may be better achieved. Price-planning platform 200 provides a critical connection between the business plans and the execution required to meet the plans. Price planning 204 may receive high-level input 210 and operation level input 212 to solve for a pricing plan that may facilitate driving the business.

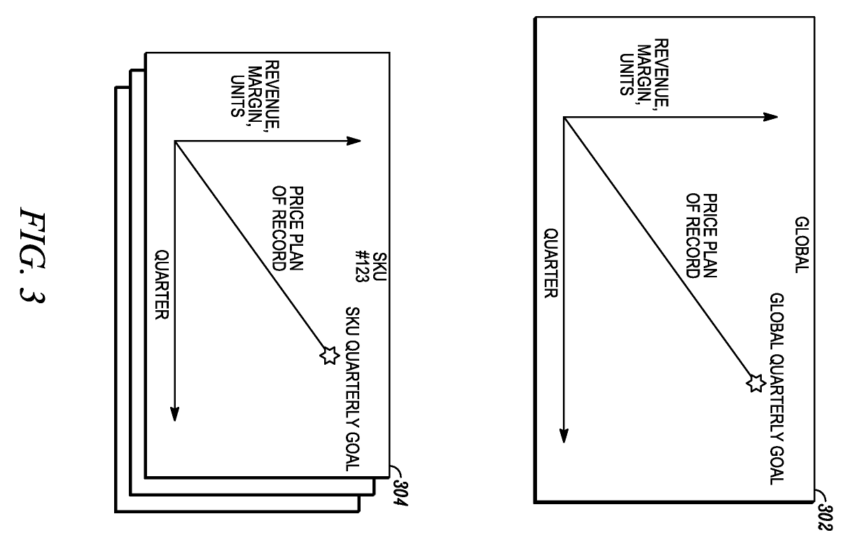

Referring to FIG. 3, a depiction of a global pricing plan of record 302 that relates financial revenue plans, demand, and or/profit margin over a planning period of time, such as a quarter, a global goal may be identified through such association. A global quarterly goal, and consequently a global pricing plan of record 302 may be composed of similar pricing plans of record for business components, such as SKUs. A plurality of component pricing plans of record 304 may be automatically derived from a global pricing plan of record 302 based on high level inputs 210 and operation level inputs 212. By decomposing a global pricing plan of record 302 into lower level components, such as SKUs, the contribution of each lower level component may be identified and thereby managed. Such a multi-tiered approach to price planning may expose and facilitate aligning assumptions used to drive the business.

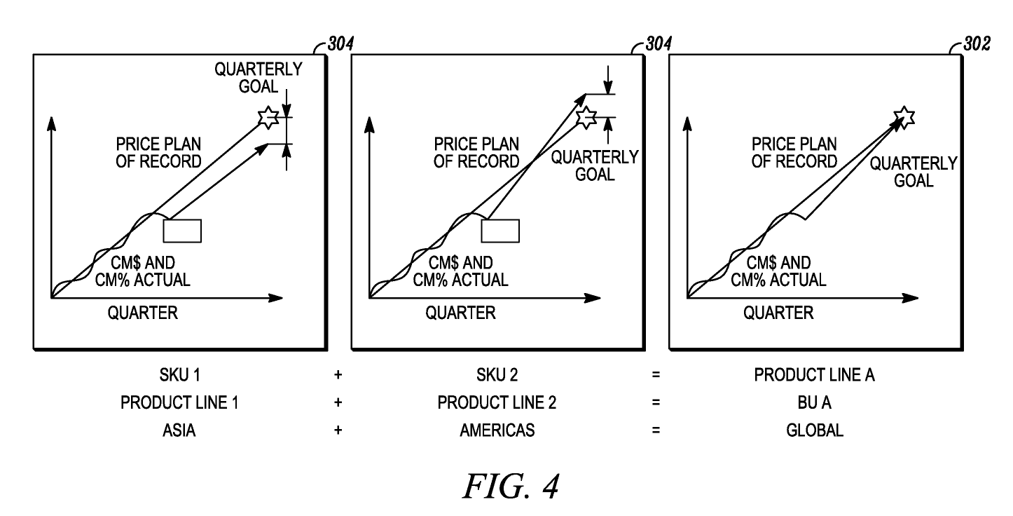

FIG. 4 shows how lower level components, such as SKUs, product lines (which may be further decomposed into SKUs), markets or regions may each be represented by a component pricing plan of record 304 and the component pricing plans of record 304 may aggregate to the global pricing plan of record 302. During a period associated with pricing plan of record 302 or 304, actual sales data may be combined with pricing plan data to develop a revised pricing plan that, in the aggregate, may result in the high level plan 202 being achieved.

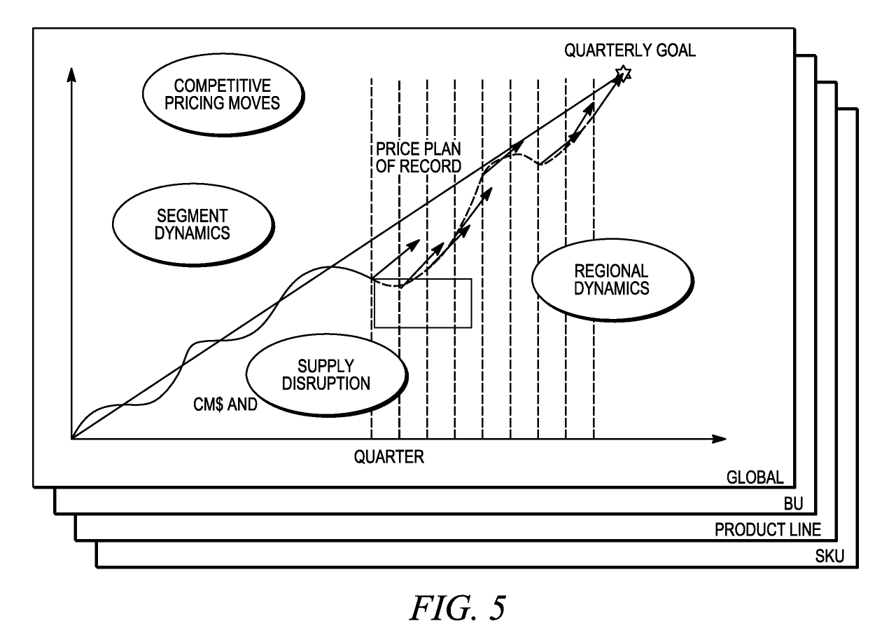

Referring to FIG. 5 which depicts a business practice of continuously re-planning pricing activity throughout a period as results are known, the price-planning platform 200 may facilitate making small adjustments at the component pricing plan of record 304 level during an operational period by taking into account additional information not available at the start of the period (e.g. supply disruption, regional dynamics, segment dynamics, competitive pricing moves, and the like). As new information is received by price planning 204, automated changes to one or more component pricing plans of record 304 may be applied to the operational level 208. Making small changes may require less effort and put less strain on a business or organization than taking major actions near an end of an operational period. Identifying component contributions to the global pricing plan of record 302 may facilitate making the small changes. Also, making small changes at the component, product, SKU, business unit, or other level may also facilitate addressing timely customer or market needs that may be overlooked without the perspective afforded by the price-planning platform 200.

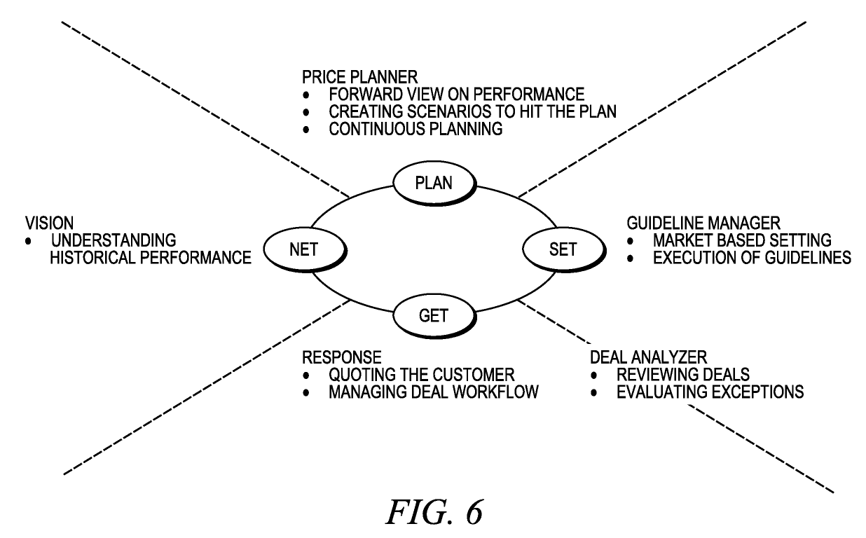

The price-planning platform 200 may provide crucial business intelligence as part of an overall business planning and operation cycle. FIG. 6 shows an exemplary business plan and operation cycle that may include planning, rule and parameter setting for operations, getting results through operations, and understanding historical performance as it may impact net results. The price-planning platform 200 facilitates determining the prices, rules, and parameters to be applied to the operations level, and facilitates analyzing net results in near real-time to support making changes to prices, rules, and/or parameters that impact the operation level of a business.

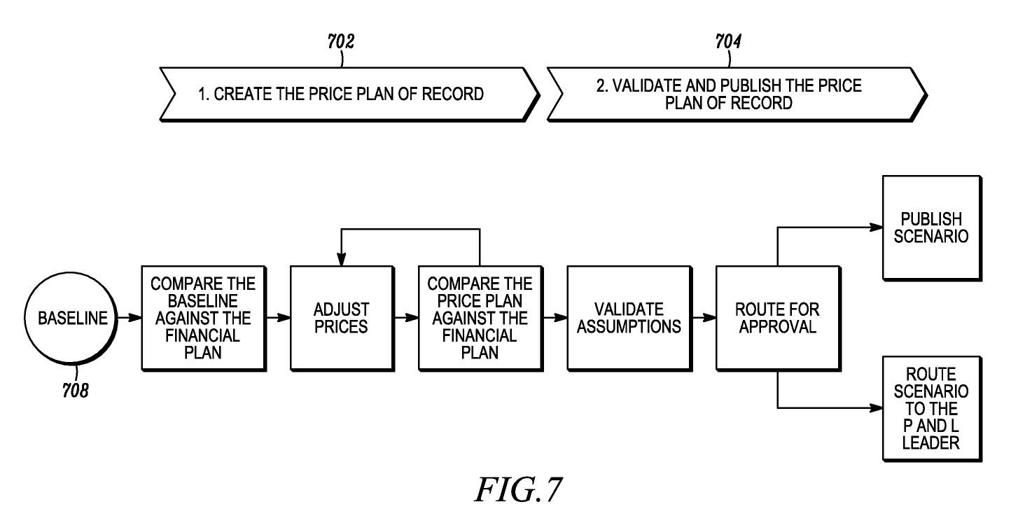

Referring to FIG. 7, an exemplary flow associated with creating a pricing plan of record, may have two major phases—creating the plan 702, and validation and publication 704 of the plan. This flow may be an embodiment of one or both of the methods described hereinafter with reference to FIGS. 21 and 22. Creating the plan 702 may consist of establishing a baseline plan 708, comparing the baseline against the high level plan 202 (such as the quarterly financial plan of the enterprise), iteratively adjusting prices or price guidelines while comparing the adjusted prices against the high level plan 202 until criteria associated with the comparison are met or approximated resulting in a set of assumptions and a pricing plan of record. The assumption and pricing plan of record are processed through the validation and publication phase 704 by validating assumptions, routing the plan for approval, and publishing the plan as a scenario to be executed by individual responsible for the operations of the enterprise.

FIG. 8 depicts an exemplary baseline input screen 802 of a user interface of the price-planning platform 200 for establishing a baseline 708. The price-planning platform 200 user interface may facilitate developing the baseline 708 by allowing a user to select aspects such as planning period 804, source code 808, geography 810 to define an intermediate component for establishing the baseline 708. The baseline input screen 802 may further display a hierarchy of low level components 812 of the selected intermediate component. The hierarchy 812 may include products, product lines, individual SKUs and the like. For each component in the hierarchy 812, the user may select an ASP (Average Selling Price) rule 814 and an ASP adjustment rule 818 associated with the baseline 708.

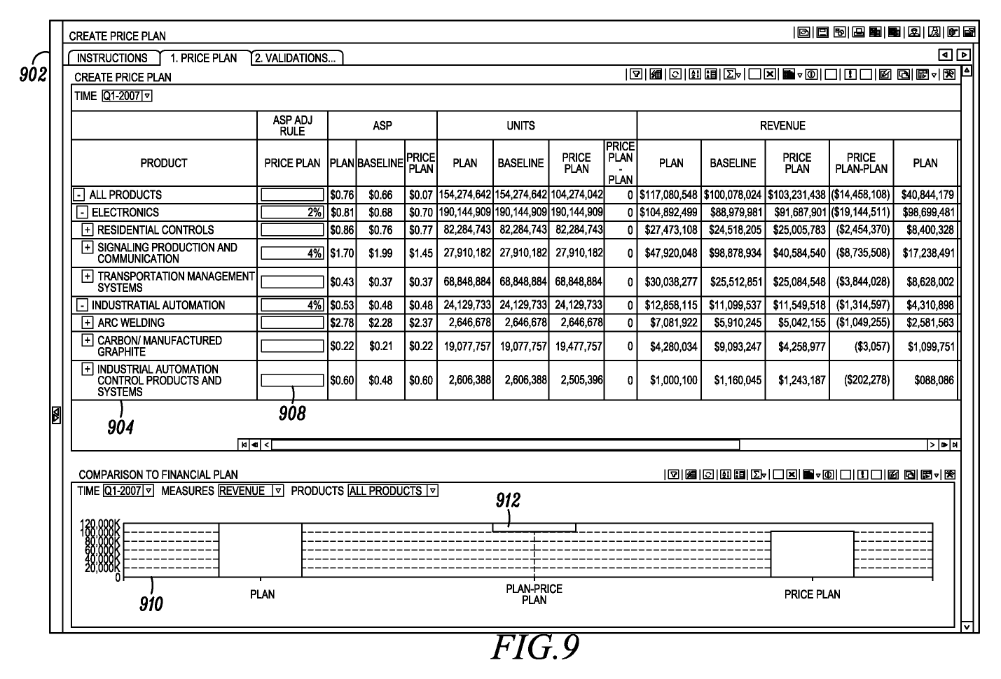

FIG. 9 depicts an exemplary user display of price plan development and comparison 902 that may be used in the creating the plan phase 702. The user display 902 shows a table 904 of average selling price data, unit volume data, and revenue data associated with the baseline 708, with the high level plan 202, and with a price plan for components in the hierarchy 812. The screen 902 may allow a user to make an adjustment in the ASP adjustment rule 908 to revise the price plan. Below the table 904 is a chart that shows a subset of the hierarchy 812 information in bar graph form 910. The user may iterate through ASP adjustment rules 908 and observe the impact of the changes in the table 904 information and the bar graph 910. When the user is satisfied with the resulting price plan, such as when the Plan-Price Plan bar 912 shown in the bar chart 910 is below a threshold, the user may save the pricing plan as a pricing plan of record.

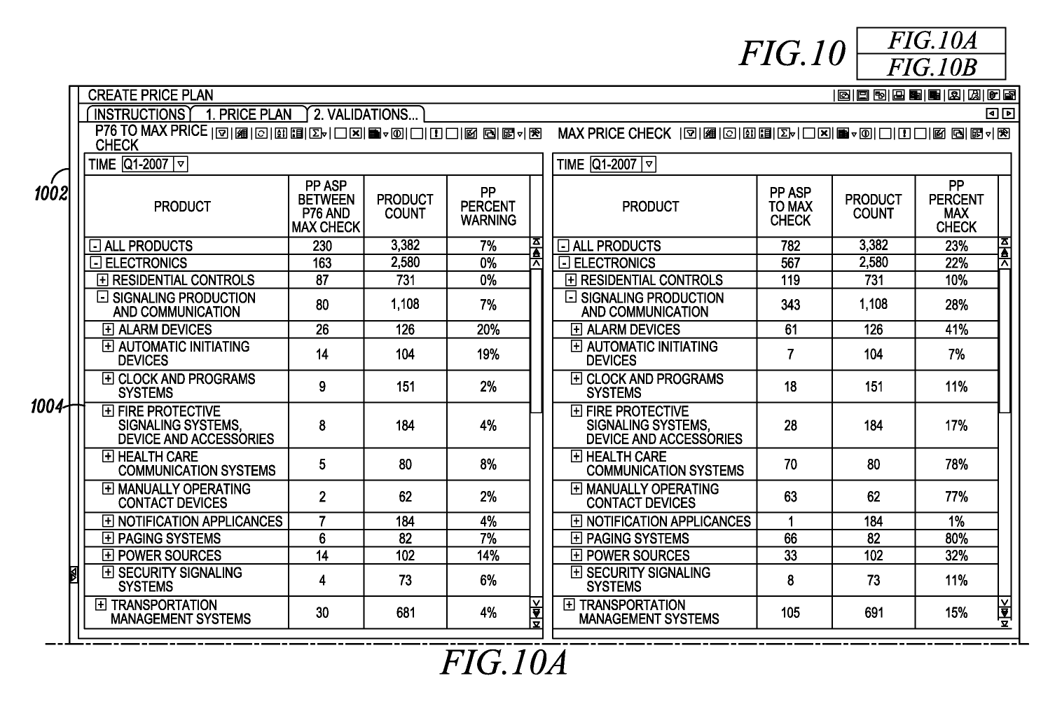

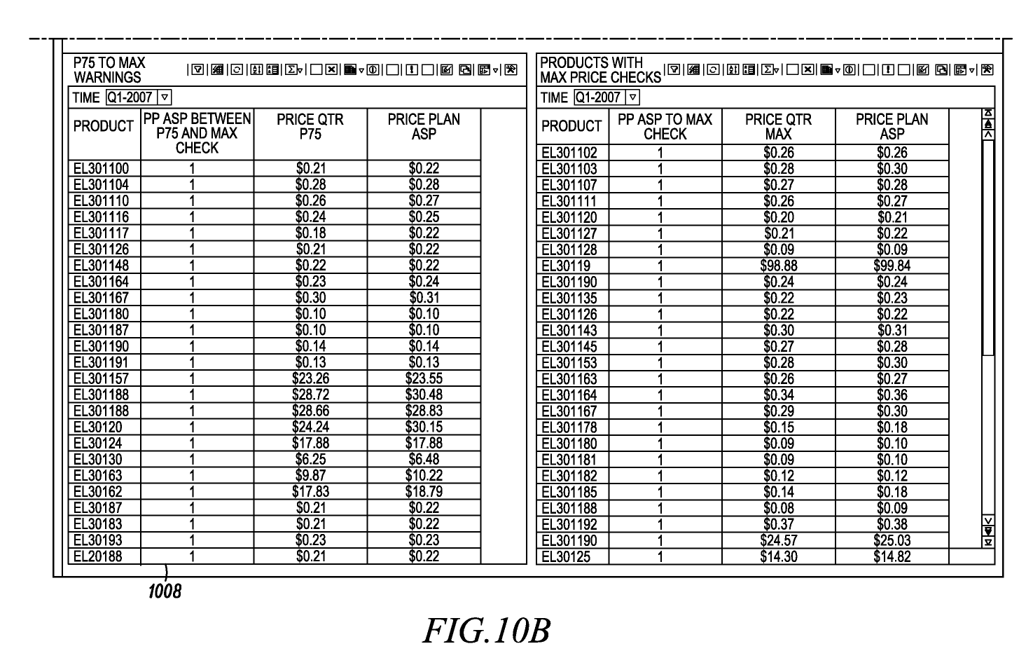

FIG. 10 depicts an exemplary validation screen 1002 of the user interface of the price-planning platform 200 that facilitates validating assumptions of a pricing plan of record. The validation screen 1002 may display data associated with the pricing plan of record for components in the hierarchy 812, or a subset of components based on a criteria or threshold. The data presented may facilitate validating aspects of the plan for products, product families and the like in table 1004, and for individual SKUs in table 1008. When a user is satisfied with the validation data presented in the validation screen 1002, the user may publish the pricing plan of record for execution by the operational levels of the business. If the user identifies a need for refinement of the pricing plan, the user may use the price plan development and comparison 902 screen to make further adjustments and then revalidate them on validation screen 1002.

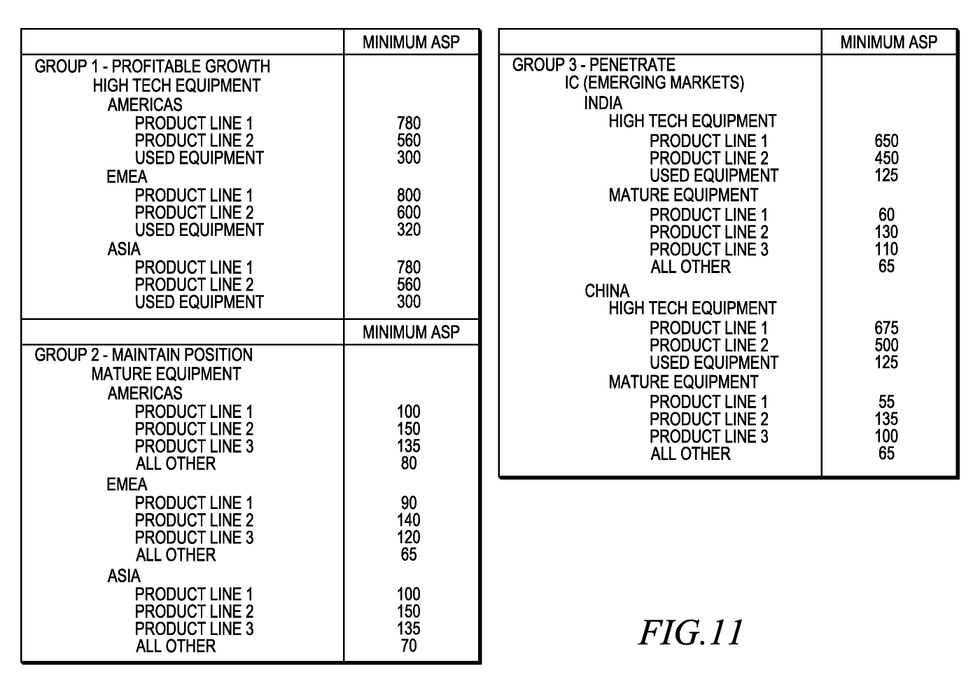

FIG. 11 depicts an alternative view of a subset of the validation screen 1002 and/or the price plan development and comparison screen 902 wherein only the minimum average selling price is shown for one or more products, product lines, regions, and the like.

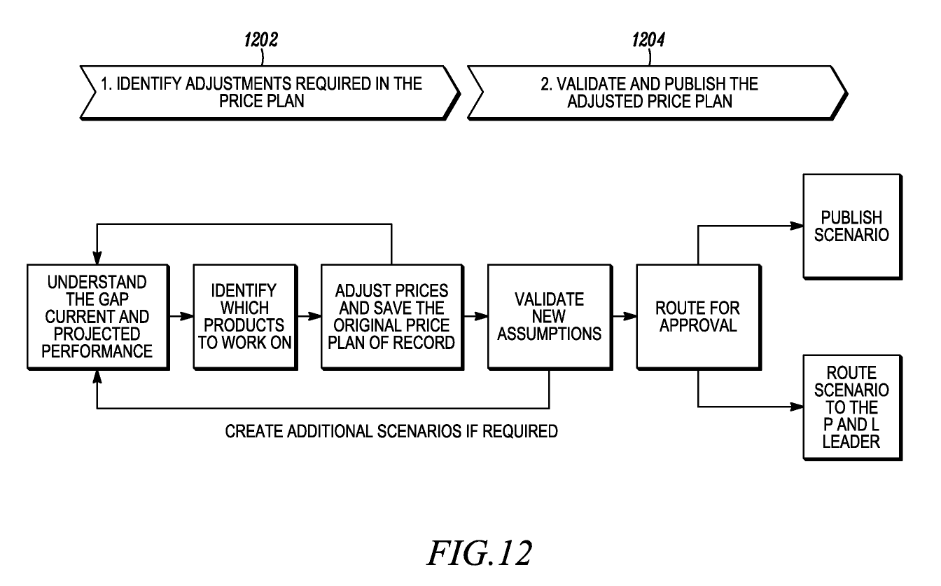

Referring to FIG. 12, a depiction of a pricing plan adjustment flow associated with pricing plan activity during an operating period, such as a financial quarter, the phases are similar to the phases of FIG. 7 in that the pricing plan is adjusted in the first phase (price plan adjustments phase 1202) and the pricing plan is validate and published in phase two 1204. The basic flow comprises understanding the gap of the current and projected performance of components used to develop the pricing plan, identifying which products, families, markets, or SKUs to work on, adjusting the prices to create an updated pricing plan of record, validating the assumptions associations with the updated pricing plan of record, routing the plan for approval, and publishing the plan.

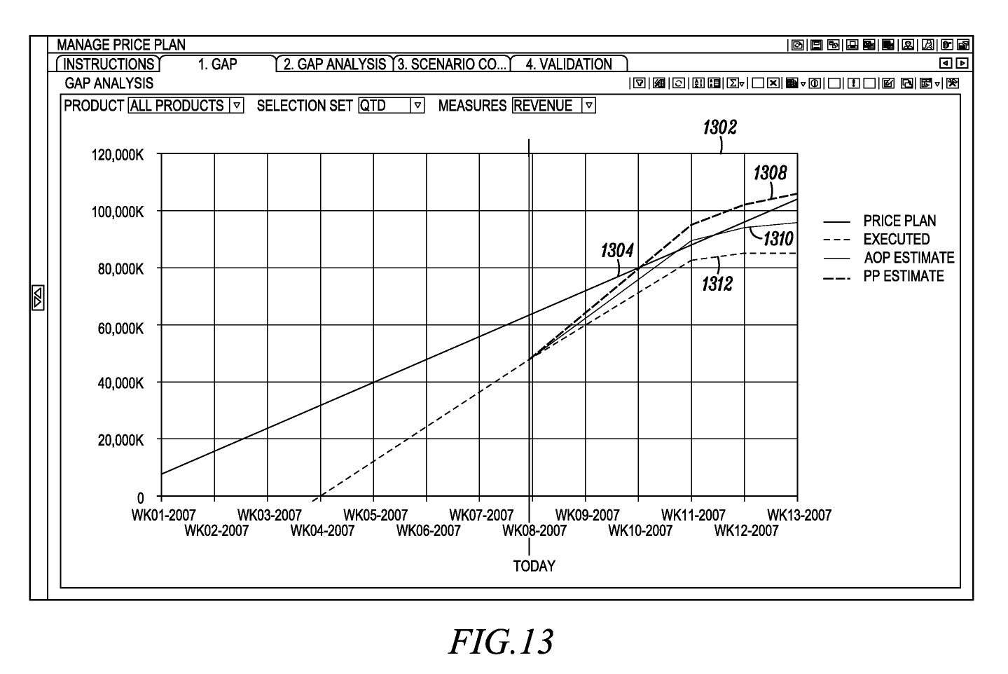

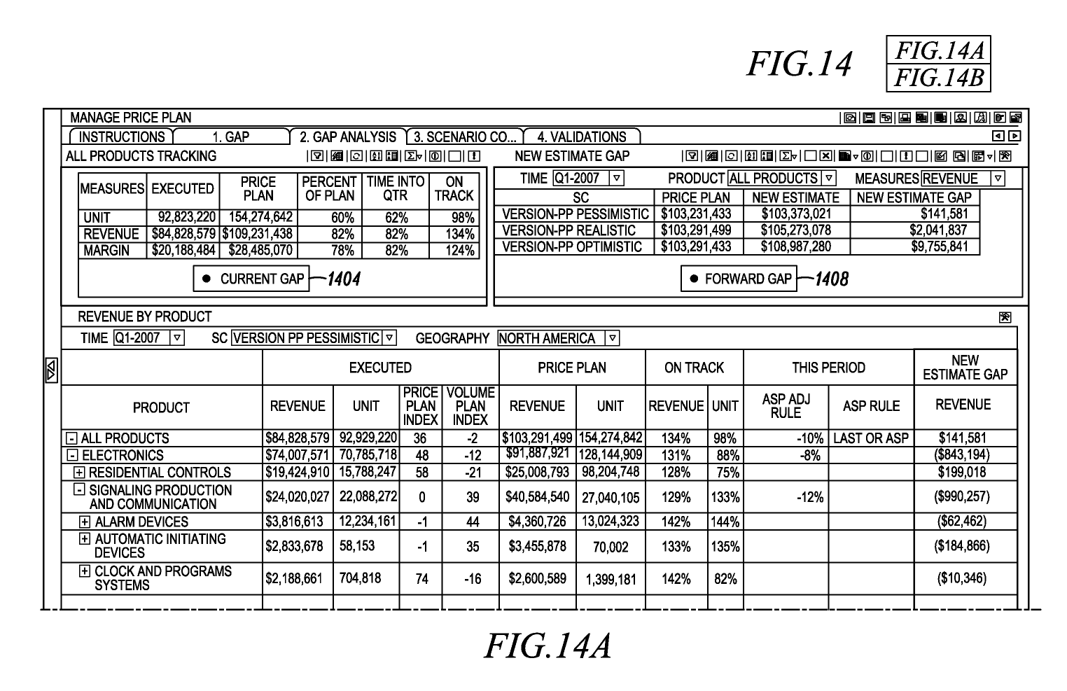

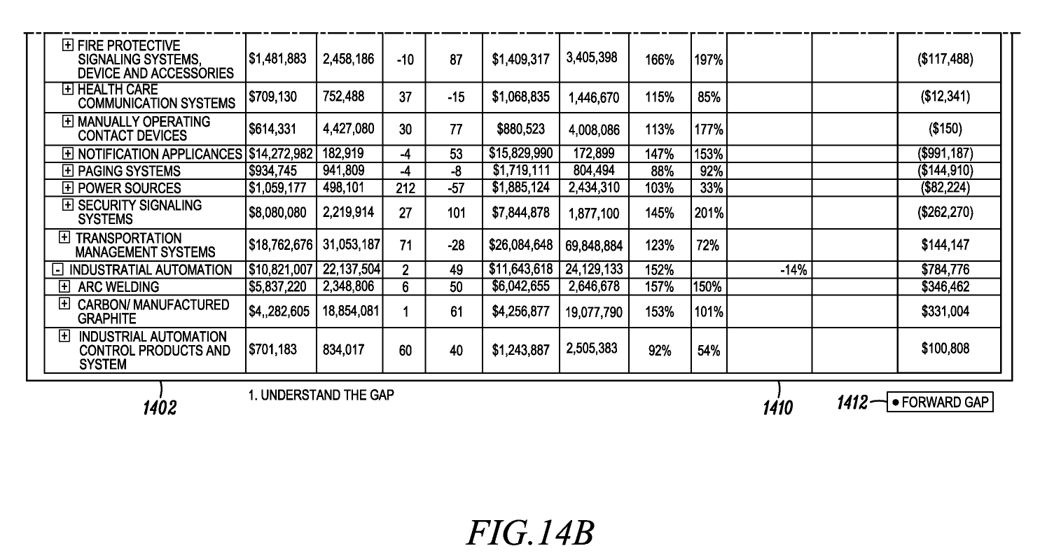

FIG. 13 shows a graph, and FIG. 14 shows a table of several aspects associated with understanding the gap in current and projected performance that lead to a revised pricing plan. In the graph 1302 of FIG. 13, the high level business plan 1304 is shown as a function of revenue dollars per week of the pricing period. On the same graph, the pricing plan 1308, the AOP estimate 1310, and an executed plan 1312 are shown for comparison.

FIG. 14 shows a multidimensional table 1402 that may facilitate understanding what products, product lines, business units, SKUs, and the like should be considered for price plan adjustments. The table 1402 provides a user with top level information associated with the current gap 1404, a reflection of revenues to date, and the forward gap 1408, a projection forward in time of revenues. Below the top level information, the table 1402 shows low level component specific performance contribution to the forward gap. Additionally, the user may enter adjustments 1410 to ASP adjustment rule and ASP rule to generate a new forward gap estimate 1412.

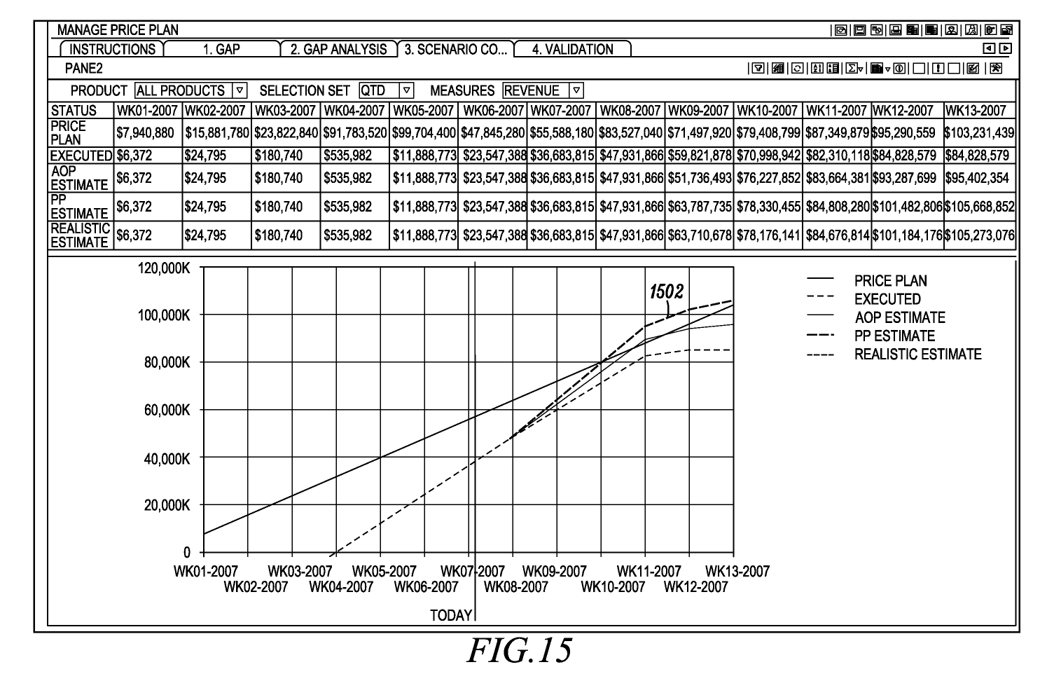

FIG. 15 shows the information from the graph of FIG. 13 with the new estimate/new pricing plan overlaid as a realistic estimate 1502 of the forward gap based on information provided by the user in the table of FIG. 14.

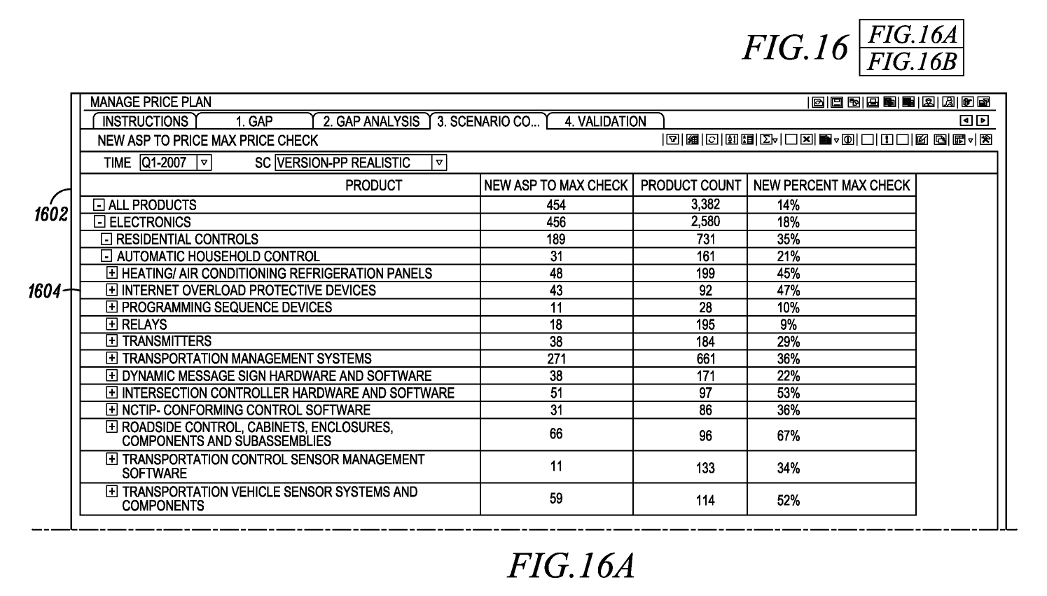

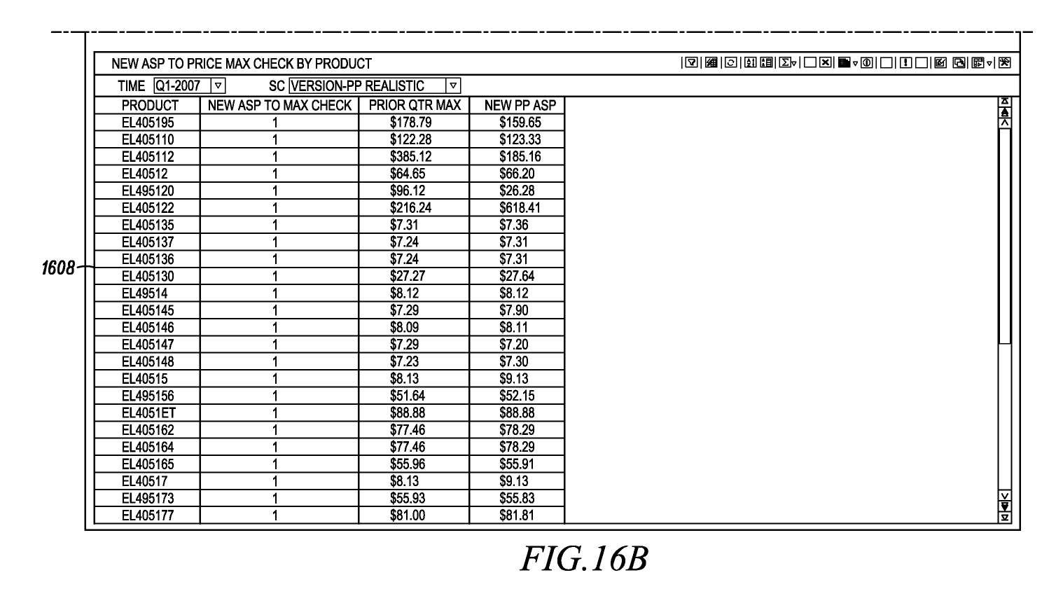

FIG. 16 depicts an exemplary validation screen 1602 of the user interface of the price-planning platform 200 that facilitates validating assumptions of the revised pricing plan resulting from user input to the table of FIG. 14. The validation screen 1602 may display data associated with the revised pricing plan of record for components in the hierarchy 812, or a subset of components based on a criteria or threshold. The data presented may facilitate validating aspects of the revised pricing plan for products, product families and the like in table 1604, and for individual SKUs in table 1608. When a user is satisfied with the validation data presented in the validation screen 1602, the user may publish the revised pricing plan of record for execution by the operational levels of the business. If the user identifies a need for further refinement of the revised pricing plan, the user may use the price plan revision table 1402 to make further adjustments and then revalidate them on validation screen 1602.

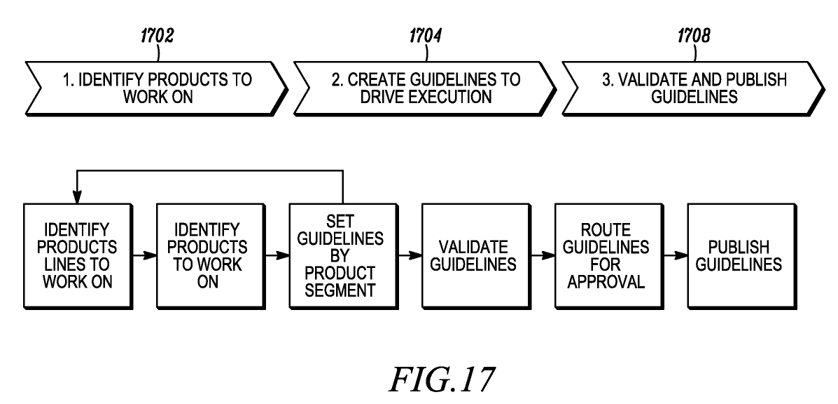

FIG. 17 depicts a guideline manager 1700 flow to facilitate managing guidelines to achieve a business plan. A guideline associated with the guideline manager may relate to a unit cost, a promotion, a discount, a time, a SKU, a range of prices, a range of dates, a range of discounts and the like. This flow may be an embodiment of the method described hereinafter with reference to FIG. 23. The flow generally includes an identify products phase 1702, a create guide lines phase 1704, and a validate and execute phase 1708. Flow is generally forward from phase 1702 to 1708, however feedback from phase 1704 to 1702 may be beneficial to setting and managing guidelines. The flow of FIG. 17 may be incorporated in a business process that also includes the price-planning platform 200. The price-planning platform 200 may provide input to the guideline manager 1700 as part of a business pricing and execution cycle.

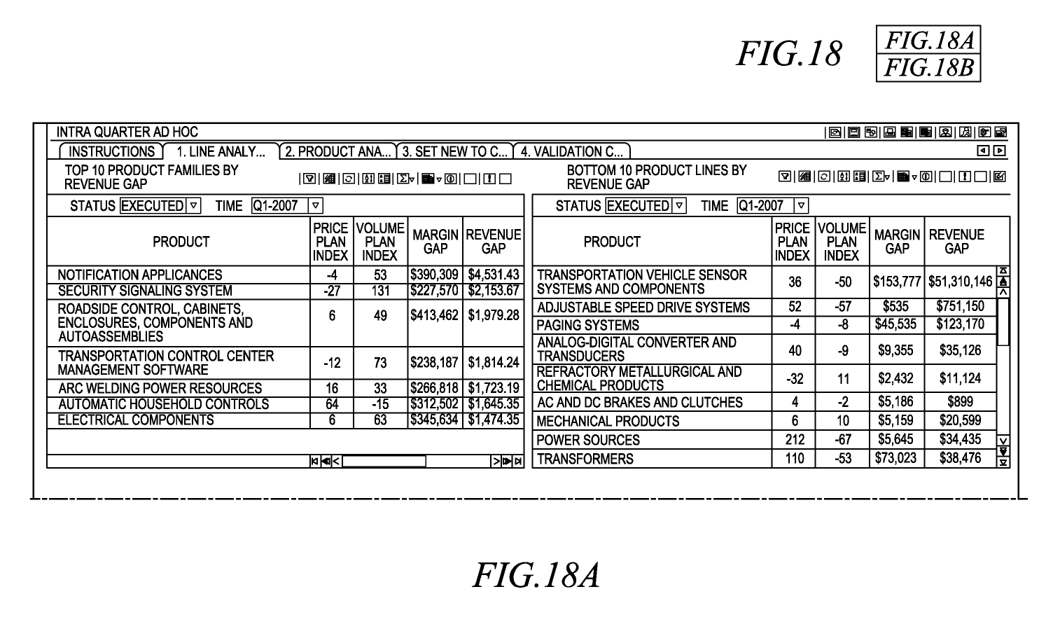

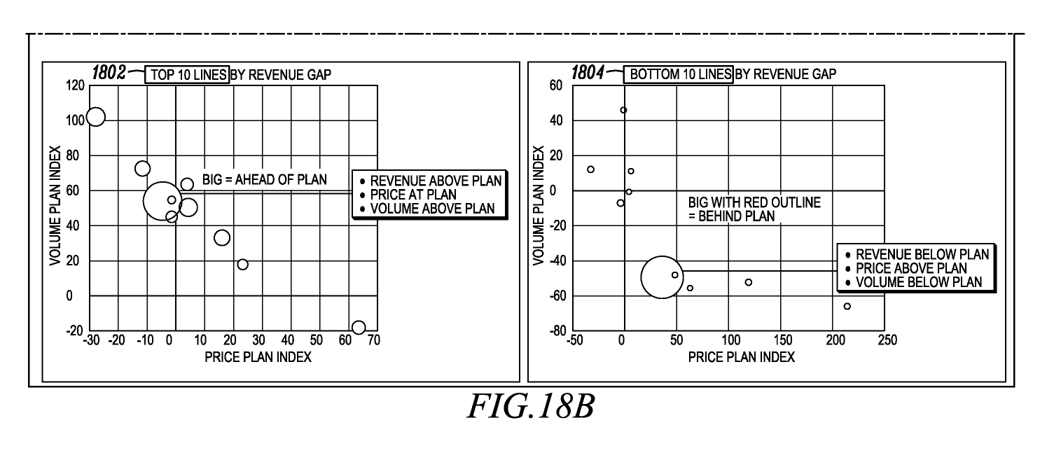

Referring to FIG. 18, the guideline manager 1700 may include interactive product line assessment screens 1802 that may show the top 10 product lines 1804 and the bottom 10 product lines 1808 to facilitate a user determining which product line pricing plan to work on. A criterion for a top 10 product line 1804 may include revenue is above plan, price is at plan, and volume is above plan. A criterion for a bottom 10 product line may include revenue is below plan, price is above plan, and volume is below plan. The assessment screen 1802 may include a product list 1808 and a x-y graph 1810 of the top 10 and/or bottom 10 product lines wherein the product lines are represented by circles on the graph. The size of the circle may be associated with the relative position of the product line in the top or bottom 10. In an example, the larger a product line circle, the higher the product line is in the top ten, and the lower the product line is in the bottom ten.

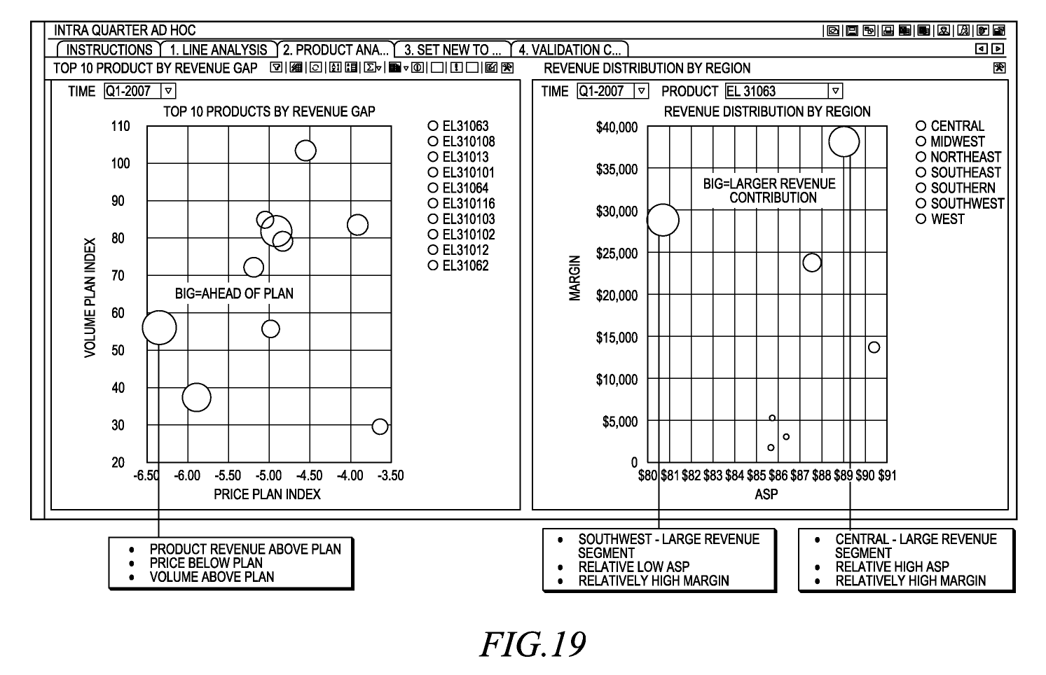

FIG. 19 depicts products and regional revenue similarly to the product lines in the graph on FIG. 18, using various size circles to represent relative position of product volume and regional revenue. Aspects that may determine a product's position on the graph and circle size include product revenue relative to plan, price relative to plan, and volume relative to plan. Regional revenue may be identified by aspects such as size of revenue segment, relative average selling price (ASP), and profit margin. A user may evaluate the information and relative size and position of circles on the graphs of FIG. 19 to determine which products, regions, or the like to work on to achieve the high level goal for the current operating period.

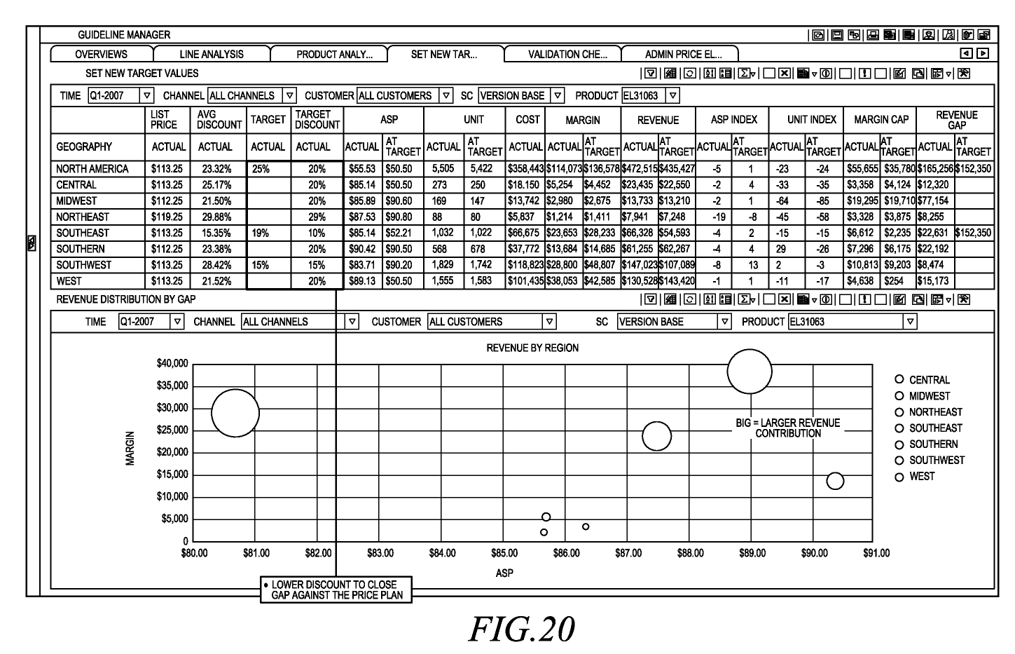

FIG. 20 depicts a business performance graph and table of the graph that facilitates a user managing discounts to achieve a pricing plan of record. In the example of FIG. 20, regional revenue is represented and discounts may be adjusted for specific regions based on a user assessment of the information presented.

In one particular embodiment, the price-planning platform 100 may solve an enterprise-planning problem. A decision object may be formulated which corresponds to the overall pricing plan. This decision object may be composed of a series of other decision objects, which may correspond to individual pricing decisions and other related decisions. A lowest common level of abstraction may be determined. In an embodiment, the lowest common level of abstraction may be determined to be the SKU. Various units, plans, functions, processes and other elements of the enterprise may feed into the pricing plan and/or the price-planning platform. A feedback engine may provide feedback. The feedback engine may allow the price-planning platform to respond in a real-time, continuous manner. Various decision makers or groups of decision makers may be associated with each plan and/or decision object. These individuals or groups of individuals may create the decision objects and may interact with the decision objects. The price-planning platform, or an analytic engine included in the price-planning platform, may perform the analysis, calculations, and the like to unify the various plans and decide or contribute to the decisions for the various decision objects.

Referring now to FIG. 21, a method for creating a pricing plan 104 begins at logical block 2102. The method 104 may then receive a baseline, as shown by 2104.

The baseline may be described in detail herein and elsewhere, and may include any and all information establishing or relating to a historical baseline of enterprise performance. For example and without limitation, the baseline may include any and all entity plans 112; adjustable parameters, attributes, and rules 114; data considered in analysis 118; and so on.

Having received the baseline, the method 104 may create a pricing plan 102, as shown by 2108. Creating the pricing plan may involve producing pricing figures that, when applied to units for sale, are projected to yield results conforming to one or more objectives in the plans 112. In embodiments, creating the pricing plan may involve optimization, modeling, inference techniques, or any and all other algorithms/heuristics. Creating the pricing plan may involve tradeoff modeling 128, which is described in detail hereinabove with reference to FIG. 1.

In any and all cases, this step of creating the pricing plan 102 may rely upon assumptions. Without limitation, these assumptions may relate to the future behavior of buyers, suppliers, markets, business environments, and the like. For example, there may be an assumed demand curve that maps unit price to unit demand. Whatever the assumptions may be, the pricing plan 102 may be created to produce substantially desirable results (e.g. meeting an objective of a plan 112) under the assumptions. Many examples of creating a pricing plan are described herein and still other examples will be appreciated. It will be understood that a variety of techniques for creating the pricing plan are possible.

Next, the method 104 may validate the assumptions, as shown by 2110. This step may involve processing of data 118 or the like. For example and without limitation, an assumption may be that a supplier will be able to meet a certain unit demand and the data 118 may be information from the supplier regarding their meeting the demand. In embodiments, the data 118 may include user input. For example and without limitation, the price-planning platform 100 may provide a query regarding the assumptions to a user via the user interface 132 and the user may in turn provide a response (that is, data 118) to the platform 100 via the user interface 132. The response may tend to support or refute the one or more of the assumptions. It will be understood that a variety of techniques for validating the assumptions are possible.

Having validated the assumptions, the method 104 may then receive approval for publishing the pricing plan, as shown by 2112. In embodiments, the approval may come in the form of user input. For example and without limitation, the price-planning platform 100 (via the user interface 132) may provide the pricing plan 102 to a user and then ask the user for approval to publish the pricing plan 102. The user may provide a response to the platform 100 via the user interface 132. Depending upon the response, the platform 100 may continue to step 2114 where the pricing plan 102 is published. In embodiments, the approval may be unconditional or conditional and may be produced automatically, manually, or according to some combination of manual and automatic steps. It will be understood that a variety of techniques for receiving approval are possible.

Having completed some or all of the aforementioned steps, the method 104 may end as shown by 2118.

Referring now to FIG. 22, a method for modifying a pricing plan 108 includes the feedback loop 130 and begins at logical block 2202. The method 104 may then receive a baseline, as shown by 2204.

The baseline may be described in detail herein and elsewhere, and may include any and all information establishing or relating to a historical baseline of enterprise performance. For example and without limitation, the baseline may include any and all entity plans 112; adjustable parameters, attributes, and rules 114; data considered in analysis 118; and so on. In any case, the baseline may include a pricing plan of record 102.

Having received the baseline, the method 108 may analyze the pricing plan of record 102 in the baseline, as shown by 2208. Analyzing the pricing plan may involve determining or estimating whether pricing figures of the pricing plan 102, when applied to units for sale, are projected to yield results conforming to one or more objectives in the plans 112. In embodiments, analyzing the pricing plan may involve optimization, modeling, inference techniques, or any and all other algorithms/heuristics. Analyzing the pricing plan may involve tradeoff modeling 128, which is described in detail hereinabove with reference to FIG. 1 and elsewhere.

By analyzing the pricing plan of record 102, the method 108 may determine that prices within the pricing plan 102 need to be reset or otherwise adjusted. As shown by 2220, the method 108 may set the prices in the pricing plan 102 in light of any and all results of analyzing the pricing plan 102. This step 2220 of setting the prices may rely upon assumptions. Without limitation, these assumptions may relate to the future behavior of buyers, suppliers, markets, business environments, and the like. For example, there may be an assumed demand curve that maps unit price to unit demand. Whatever the assumptions may be, the prices in the pricing plan 102 may be set to produce substantially desirable results (e.g. meeting an objective of a plan 112) under the assumptions. Many examples of setting the prices in a pricing plan 102 are described herein and still other examples will be appreciated. It will be understood that a variety of techniques for setting the prices in the pricing plan 102 are possible.

Next, the method 108 may effectively branch its execution. One branch proceeds out of the feedback loop 130 and include the steps of validate assumptions 2110; receive approval, if required 2112; and publish pricing plan 2114. These steps 2110, 2112, and 2114 may be described in detail hereinabove with reference to FIG. 21. The other branch remains within the feedback loop 130 and continues to step 2222.

The method 108 may receive one or more entity plans 112 or updates thereto, as shown by 2222.

At step 2224, the method 108 may receive adjustable parameters, attributes, and rules 114. Such parameters, attributes, and rules 114 may indicate a change since the pricing plan of record 102 was created or since the prices were set. The change may relate to assumptions upon which the pricing plan 102 depends. Therefore, the change may impact the expected effectiveness or correctness of the pricing plan 102. For example and without limitation, the change may relate to a supplier that can now supply more units in the coming quarter; a customer that is delaying future orders by one week; a tightening of credit markets that may limit an enterprise's ability to expand inventory to a level sufficient to support sales targets in a demand plan 140; a special customer order that was approved by an enterprise's management but not in accordance with the pricing plan 102; and so on. It will be understood that a wide variety of changes are possible.

Continuing on, the method 108 may receive data considered in analysis 118, as shown by step 2228. The data 118 may have been described in detail hereinabove with reference to FIG. 1 and elsewhere. In any case, the price-planning platform 100 may utilize the data 118 to monitor effects of the pricing plan of record 102, track deviations between the expected results of the pricing plan of record 102 and the actual results, and so on. The data 118 may indicate the change since the pricing plan of record 102 was created or since the prices were set.

Returning to step 2208, the method 108 may again analyze the pricing plan of record 102, this time in light of both the baseline received in step 2204 and the entity plans 112 or updates thereto; the adjustable parameters, attributes, and rules 114; and the data 118, all of which were received in steps 2222, 2224, and 2228 respectively. From here, processing continues to step 2220 and beyond, as described hereinabove.

The feedback loop 130 may include steps 2208, 2220, 2222, 2224, and 2228. In the feedback loop 130, information (e.g. 112, 114, and 118) may be received from time to time. This information may be fed back into the step 2208 of analyzing the pricing plan 102, which drives the step of setting prices 2220. In this way, the pricing plan of record 102 may be updated iteratively and in response to information that arrives or changes over time.

In embodiments, the feedback loop 130 may allow an enterprise to adjust its pricing over time in order to meet objectives. For example and without limitation, an enterprise may have a quarterly revenue goal. On the first day of the quarter, a price per unit is set for the enterprise's product. During the course of the quarter, the price-planning platform 100 may monitor the enterprise's progress toward the goal. If revenue is lagging, the price-planning platform 100 and/or users of the platform 100 may review what the enterprise has done in the past to remedy such a situation. A remedy in the form of an adjustment to the pricing plan of record 102 may then be applied, perhaps well in advance of the end of the quarter.

Referring now to FIG. 23, a method 2300 of a guideline manager 110 may begin at step 2302. Then, the method 2300 may receive a pricing plan or record 102, as shown by step 2304.

Based upon one or more performance metrics associated with units for sale, the method 2300 may identify particular units to which guidelines will be applied. In embodiments and without limitation, the units may include products lines, products within product lines, and so on.

Next, the guidelines are set for the identified units, as shown by step 23 10. For example and without limitation, a unit may be selling in far lesser volume than called for by a demand plan 140. In response to this, a guideline may be set, the guideline issuing instructions to salespeople regarding the units (for example, “you can sell these units @ $5 plus or minus $1; but for the next two weeks you can offer a 20 point discount”). It will be understood that a variety of guidelines are possible.

The method 2300 may then validate the guidelines, as shown by 2310. This step 2310 may involve checking to see that the guidelines comply with adjustable parameters, attributes, and rules 114. In embodiments, this step 2310 may include soliciting and/or receiving user input. For example and without limitation, the price-planning platform 100 may provide a query regarding the guidelines to a user via the user interface 132 and the user may in turn provide a response (that is, data 118) to the platform 100 via the user interface 132. The response may tend to validate or invalidate the one or more of the assumptions. It will be understood that a variety of techniques for validating the assumptions are possible.

If required approval to publish the guidelines is necessary or desirable, the method 2300 may request and/or receive approval to publish the guidelines, as shown by 2314. In embodiments, this step 2314 may include soliciting and/or receiving user input via the user interface 132.

Then the method may publish the guidelines, as shown by 2318. Such publication may occur via the system/application interface 134 and/or the user interface 132.

Finally, the method 2300 concludes at step 2320.

Any and all communications described hereinabove as occurring via the user interface 132 and/or between the price-planning platform 100 and a user may additionally or alternatively occur via the system/application interface 134 and/or between the price-planning platform 100 and a remote system or application, and vice versa. It will be understood that a variety of such additional or alternative embodiments are possible.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method for creating a pricing plan, the method comprising:
receiving a baseline, the baseline including at least one entity plan;
creating a pricing plan, the pricing plan including pricing guidelines that, when applied to units for sale, are projected to yield results conforming to at least one objective of the at least one entity plan;
validating an assumption, the assumption used in creating the pricing plan; and making the pricing plan available to a price planner for implementing the pricing guidelines.

2. The method of claim 1 further comprising, receiving approval to transmit the pricing plan.

3. The method of claim 1, wherein making the pricing plan available occurs via a user interface.

4-8. (canceled)

9. The method of claim 1, wherein receiving occurs via a user interface.

10-12. (canceled)

13. The method of claim 1, wherein the entity plan is a promotion plan.

14-19. (canceled)

20. The method of claim 1, wherein the entity plan is an enterprise plan.

21-25. (canceled)

26. The method of claim 1, wherein the baseline further comprises at least one of an adjustable parameter, an adjustable attribute, and an adjustable rule.

27-30. (canceled)

31. The method of claim 1 further comprising transmitting an alert when validating the assumption fails.

32-33. (canceled)

34. A system for creating a pricing plan, the system comprising:
a price-planning platform having an input module, a facility for creating a pricing plan, and an output module, the pricing plan directed at fulfilling goals of both a financial plan and a demand plan, wherein
the input module is adapted to receive a baseline, the baseline comprising the financial plan and the demand plan, and
the output module is adapted to make available the pricing plan.

35. The system of claim 34, wherein the input comprises a user interface.

36-37. (canceled)

38. The system of claim 34, wherein the input comprises an application interface.

39. The system of claim 34, wherein the output comprises a user interface.

40-41. (canceled)

42. The system of claim 34, wherein the output comprises an application interface.

43-49. (canceled)

50. A method for creating a pricing plan, the method comprising:
receiving a baseline, the baseline comprising at least two entity plans;
creating a pricing plan, the pricing plan including pricing figures that, when applied to units for sale, are projected to yield results substantially conforming to objectives of the at least two entity plans;
validating an assumption, the assumption used in creating the pricing plan;
creating a guideline related to the pricing plan; and
making available the pricing plan and the guideline.

51. The method of claim 50 further comprising, receiving approval to transmit the pricing plan.

52. (canceled)

53. The method of claim 50, wherein making available occurs via a dashboard.

54-55. (canceled)

56. The method of claim 50, wherein making available further comprises transmitting a guideline, the guideline related to the pricing plan of record.

57-58. (canceled)

59. The method of claim 50, wherein receiving occurs via a dashboard.

60-61. (canceled)

62. The method of claim 50, wherein the entity plans comprise a promotion plan.

63-68. (canceled)

69. The method of claim 50, wherein the entity plans comprise an enterprise plan.

70-74. (canceled)

75. The method of claim 50, wherein the entity plans comprise a financial plan and a demand plan.

76-88. (canceled)

89. The method of claim 50, wherein the guideline comprises a range of prices.

90. The method of claim 50, wherein the guideline comprises a range of dates.

91. The method of claim 50, wherein the guideline comprises a range of discounts.

92. A price-planning platform, comprising:
an input module adapted to receive a baseline, the baseline comprising at least two entity plans;
a facility adapted to create a pricing plan, the pricing plan including pricing figures that, when applied to units for sale, are projected to yield results substantially conforming to objectives of the at least two entity plans;
a facility adapted to validate an assumption, the assumption used in creating the pricing plan;
a guideline manager adapted to create a guideline related to the pricing plan; and an output module adapted to make available the pricing plan and the guideline.

93. The price-planning platform of claim 92, wherein making available occurs via a user interface.

94-95. (canceled)

96. The price-planning platform of claim 92, wherein making available occurs via an application interface.

97-98. (canceled)

99. The price-planning platform of claim 92, wherein receiving occurs via a user interface.

100-101. (canceled)

102. The price-planning platform of claim 92, wherein receiving occurs via an application interface.

103. The price-planning platform of claim 92, wherein the entity plans comprise a promotion plan.

104-109. (canceled)

110. The price-planning platform of claim 92, wherein the entity plans comprise an enterprise plan.

111-115. (canceled)

116. The price-planning platform of claim 92, wherein the entity plans comprise a financial plan and a demand plan.

117-129. (canceled)

130. The price-planning platform of claim 92, wherein the guideline comprises a range of prices.

131. The price-planning platform of claim 92, wherein the guideline comprises a range of dates.

132. The price-planning platform of claim 92, wherein the guideline comprises a range of discounts.

133-141. (canceled)
